(19) United States
(12) Patent Application Publication
(10) Pub. No.: US 2024/0129891 A1
(43) Pub. Date: Apr. 18, 2024

(54) BEAM-SPECIFIC MOTION STATE DETECTION CONFIGURATION AND REPORTING

(71) Applicant: QUALCOMM Incorporated, San Diego, CA (US)

(72) Inventors: Alexandros MANOLAKOS, Escondido, CA (US); Weimin DUAN, San Diego, CA (US); Xiaoxin ZHANG, Sunnyvale, CA (US)

(21) Appl. No.: 18/277,569

(22) PCT Filed: Jan. 27, 2022
(86) PCT No.: PCT/US2022/014016

§ 371 Date: Aug. 16, 2023

(30) Foreign Application Priority Data
Mar. 18, 2021 (GR) 20210100173

(51) Int. Cl. H04W 64/00; H04B 7/06; H04B 17/318; H04L 5/00

(52) U.S. Cl. CPC H04W 64/006; H04B 7/06968; H04B 17/318; H04L 5/0051

(57) ABSTRACT

Motion detection services are performed in a wireless network (e.g., a cellular network) with reference to beamforming. Reference signals or other resources for motion detection based on RAdio Detection And Ranging (RADAR) are transmitted over one or more transmit beams or received over one or more receive beams. Any motion measured from reflections of the signals may be associated with one or more of the transmit or receive beams. A device configured to receive the reflections determines one or more motion measurements associated with one or more beams, and determines one or more motion state metrics associated with the one or more beams. The one or more motion state metrics are included in one or more motion state reports to a network entity (e.g., a radar server), which may be used for various operations in the wireless network.

### CROSS-REFERENCE TO RELATED APPLICATIONS

This application claims priority to and the benefit of Greek Patent Application No. 20210100173, entitled “BEAM-SPECIFIC MOTION STATE DETECTION CONFIGURATION AND REPORTING,” filed Mar. 18, 2021, which is assigned to the assignee hereof and which is expressly incorporated herein by reference in its entirety.

### BACKGROUND

### Field

Subject matter disclosed herein relates to motion state detection of user equipment and more particularly to determining and reporting a user equipment's motion state based on beam-specific information.

### Information

The motion state information of a user equipment (UE), such as a cellular telephone, may be useful or essential to a number of applications including navigation, direction finding, cell selection, and asset tracking. The motion of a UE may be determined based on information gathered from various systems. For example, RAdio Detection And Ranging (RADAR, also referred to as Radar or radar) systems may be used to determine a motion state of a device based on radio frequency (RF) signals reflected by the device. In a wireless network (e.g., a cellular network implemented according to 4G (also referred to as Fourth Generation) Long Term Evolution (LTE) radio access or 5G (also referred to as Fifth Generation) “New Radio” (NR)), a base station may transmit RF signals that are used for radar, the RF signals are reflected by the UE, and the base station may receive the reflected signals. Information regarding the reflections may be compared to information regarding the originally transmitted RF signals to determine a motion state of the UE. Improvements in determining and reporting motion state information are desirable.

### SUMMARY

A base station or other device configured for beam forming transmits RF signals along transmit beams and receives RF signals along receive beams. Each beam has an orientation associated with the device, and the RF signals along the beam travel to or from the device along a direction associated with the beam's orientation. The device supporting motion detection services transmits reference signals for radar along one or more transmit beams, and reflections of the reference signals are obtained by the device or another device along one or more receive beams. Motion state metrics are determined based on the obtained reflections, and the motion state metrics are reported to a radar server of the wireless network to determine a motion state of a UE. With the radar reference signals of the reflections being received along one or more receive beams or originally being transmitted along one or more transmit beams, the motion state metrics are associated with the receive or transmit beams. The device reporting the motion state metrics or the radar server determining a motion state from the motion state metrics are based on the receive or transmit beams.

In one implementation, a method for supporting motion detection services in a wireless network includes: obtaining one or more reflections of signals transmitted by a first device, wherein the signals are associated with one or more beams of the first device; determining one or more motion state metrics based on the one or more reflections; and providing a motion state report to a network entity in the wireless network. The motion state report includes the one or more motion state metrics.

In one implementation, a device configured for supporting motion detection services in a wireless network includes at least one transceiver, at least one memory, and at least one processor coupled to the at least one transceiver and the at least one memory. The at least one processor is configured to cause the device to: obtain, via at least one transceiver, one or more reflections of signals transmitted by a first device, where the signals are associated with one or more beams of the first device; determine, via the at least one processor, one or more motion state metrics based on the one or more reflections; and provide, via the at least one transceiver, a motion state report to a network entity in the wireless network. The motion state report includes the one or more motion state metrics.

In one implementation, a non-transitory computer-readable medium stores instructions that, when executed by at least one processor of a device configured for supporting motion detection services in a wireless network, causes the device to: obtain, via at least one transceiver, one or more reflections of signals transmitted by a first device, where the signals are associated with one or more beams of the first device; determine, via the at least one processor, one or more motion state metrics based on the one or more reflections; and provide, via the at least one transceiver, a motion state report to a network entity in the wireless network. The motion state report includes the one or more motion state metrics.

In one implementation, a device for supporting motion detection services in a wireless network includes: means for obtaining one or more reflections of signals transmitted by a first device, wherein the signals are associated with one or more beams of the first device; means for determining one or more motion state metrics based on the one or more reflections; and means for providing a motion state report to a network entity in the wireless network. The motion state report includes the one or more motion state metrics.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to various aspects of the disclosure.

FIG. 2 illustrates a block diagram of a design of base station and user equipment (UE), which may be one of the base stations and one of the UEs in FIG. 1.

FIG. 3 illustrates a UE capable of supporting motion detection services in a wireless network.

FIG. 4 illustrates a base station capable of supporting motion detection services in a wireless network.

FIG. 5 shows a flowchart for an exemplary method for supporting motion detection services in a wireless network.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular Radio Access Technology (RAT), unless otherwise noted. In general, a UE may be any wireless communication device (e.g., a mobile phone, router, tablet computer, laptop computer, tracking device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” “mobile device,” or variations thereof Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a New Radio (NR) Node B (also referred to as a gNB), etc. In addition, in some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). A communication link through which a UE signals to another UE is called a sidelink (SL) or sidelink channel. As used herein, the term traffic channel (TCH) can refer to either an UL/reverse, DL/forward, or SL traffic channel.

The term “base station” may refer to a single physical transmission-reception point (TRP), which may also be referred to as a transmit/receive point, or to multiple physical TRPs that may or may not be co-located. For example, where the term “base station” refers to a single physical TRP, the physical TRP may be an antenna of the base station corresponding to a cell of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring.

Radar solutions for motion detection may be defined in the Third Generation Partnership Project (3GPP) set of standards for LTE (4G) and New Radio (NR) for Fifth Generation (5G), the Institute of Electrical and Electronics Engineers (IEEE) set of standards for wireless local area networks (WLAN), or other standards bodies for wireless communications. A radar solution may employ a radar server to support determining motion states of UEs in a wireless network (e.g., a cellular network). The radar server may be part of or accessible from a serving network or a home network for a UE or may simply be accessible over the Internet or over a local Intranet. If motion detection services of a UE is needed, a radar server may indicate the RF signals to be used for motion detection and the motion state metrics to be determined and provided to the radar server. The radar server may also track motion state information obtained for UEs in the wireless network, which may be used for cell selection, positioning, or other services of the wireless network for the UE. While a radar server is described as performing certain operations, such operations may be performed by any suitable network entity (such as a core network device, a base station, a location server, or other suitable device of the wireless network).

A radar server (or other suitable network entity) and a base station (e.g. a gNodeB (gNB)) may exchange messages to (i) configure the base station or a UE to transmit signals defined for motion detection, (ii) configure the base station or a UE to receive reflections of the transmitted signals, (iii) configure the base station or a UE to generate motion state metrics from the received reflections, and (iv) enable the radar server (or the other suitable network entity) to obtain the motion state metrics from the base station (which may be determined by the base station or obtained from a UE).

The base station in the wireless network may be configured for beam forming. In this manner, a transmit beam or a receive beam of the base station is focused in a general direction from or to the base station. Focusing the beam allows the range in the direction from or to the device to increase without increasing the power of the transmitted signals. Radar signals may be transmitted along one or more transmit beams, or reflections of the radar signals may be received along one or more receive beams for motion detection services. If reflections of signals are received along multiple receive beams or the reflections received are from signals transmitted along multiple transmit beams, the difference in orientation between beams may cause a difference in motion measurements between the beams. For example, if determining a motion measurement includes measuring a phase difference between the originally transmitted signal and the reflected signal that is obtained, the phase difference for a signal transmitted or received along a beam that is substantially parallel to the UE's axis of movement is greater than the phase difference for a signal transmitted or received along a beam that is substantially perpendicular to the UE's axis of movement. In another example, a beam oriented on one side of a device may not include transmitted or received signals reflected by an object if the object is positioned on the other side of the device. Multiple motion state metrics associated with different beams may be used by the network entity (e.g., a radar server) to determine an overall motion state of a UE.

Enhancements to measuring motion state metrics and reporting motion state metrics in the presence of beamforming are desirable. As noted above, one of the limitations in motion detection services in the presence of beamforming is variations in motion measurements based on the different beams. For example, reflections may have a different phase or be received at a different time based on which transmit beam transmits the original signal or which receive beam receives the reflection.

Accordingly, as described herein, enhancements to determine the motion state metrics and report the motion state metrics for a network entity (e.g., the radar server) to determine the overall motion state of a UE is described. In one implementation, a device obtains one or more reflections of signals transmitted by a first device. The first device may be a base station (such as a gNB) or a UE transmitting radar reference signals determined by the network entity (e.g., the radar server) to be used for determining a motion state of the UE. The device obtaining the reflections may be the base station, UE, or a neighboring UE. If the first device is the base station, the reflections may be from the UE. If the first device is the UE, the reflections may be from objects in the UE's environment. The device obtaining the one or more reflections determines one or more motion state metrics associated with one or more beams of the first device (such as an indication of a phase difference associated with the originally transmitted signal defined by the network entity (e.g., the radar server) and the obtained reflection). The one or more beams may include one or more transmit beams, or the one or more beams may include one or more receive beams if the device and the first device are the same device (such as the base station or the UE both transmitting the signals and obtaining the reflections). The device also provides a motion state report to a network entity in the wireless network. If the device is the base station, the network entity may be the radar server or another component of the core network communicably coupled to the radar server. If the device is the UE or a neighboring UE, the network entity may be the base station or a relay UE. The suitable network entity (e.g., the radar server) of the wireless network determines a motion state of the UE based on the one or more motion state metrics included in the motion state report. The motion state may include a position of the UE, a speed, velocity or other degree of motion of the UE, or an indication of a range of motion associated with the UE (such as ranges “no motion,” “slow motion,” or “fast motion” based on the degree of motion and thresholds associated with the ranges of motion).

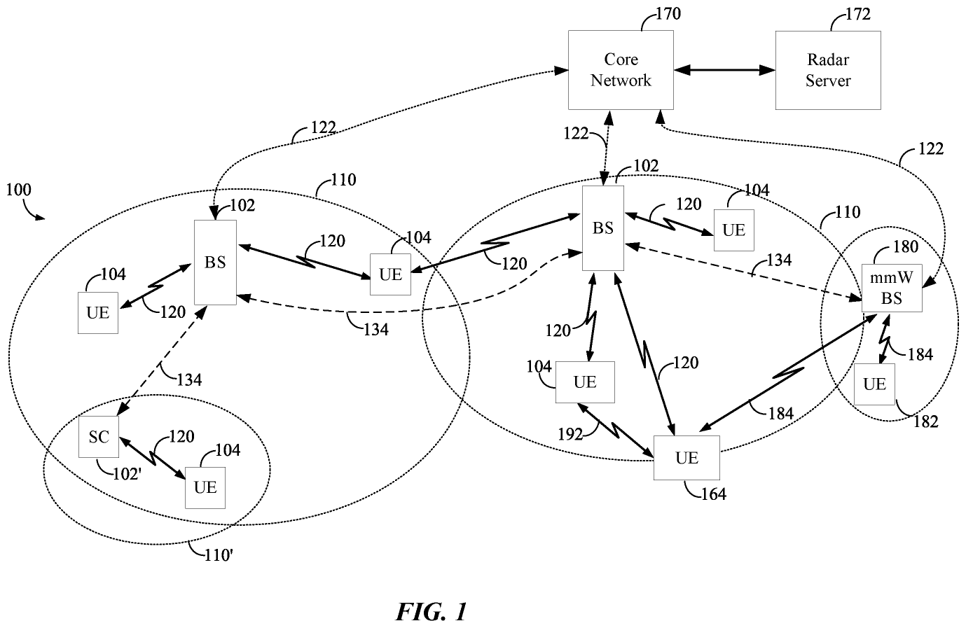

FIG. 1 illustrates an example wireless communications system 100. The wireless communications system 100 (which may also be referred to as a wireless wide area network (WWAN) or a wireless network (e.g., a cellular network) may include various base stations 102, sometimes referred to herein as gNBs 102 or other types of NBs, and various UEs 104. The base stations 102 may include macro cell base stations (high power wireless base stations) and/or small cell base stations (low power wireless base stations). In an aspect, the macro cell base station may include eNBs where the wireless communications system 100 corresponds to an LTE network, or gNBs where the wireless communications system 100 corresponds to a 5G network, or a combination of both, and the small cell base stations may include femtocells, picocells, microcells, etc.

The base stations 102 may collectively form a RAN and interface with a core network 170 (e.g., an evolved packet core (EPC) or next generation core (NGC)) through backhaul links 122, and through the core network 170 to one or more radar servers 172. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/NGC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCID), a virtual cell identifier (VCID)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include UL (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to DL and UL (e.g., more or less carriers may be allocated for DL than for UL).

The small cell base station 102′ may operate in a licensed and/or an unlicensed frequency spectrum. When operating in an unlicensed frequency spectrum, the small cell base station 102′ may employ LTE or 5G technology and use the same 5 GHz unlicensed frequency spectrum as used by a WLAN AP. The small cell base station 102′, employing LTE/5G in an unlicensed frequency spectrum, may boost coverage to and/or increase capacity of the access network. LTE in an unlicensed spectrum may be referred to as LTE-unlicensed (LTE-U), licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels. A secondary carrier is a carrier operating on a second frequency (e.g., FR2) that may be configured once the RRC connection is established between the UE 104 and the anchor carrier and that may be used to provide additional radio resources. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include one or more UEs that connects indirectly to one or more communication networks via one or more device-to-device (D2D) peer-to-peer (P2P) links. In the example of FIG. 1, UE 164 has a D2D P2P link 192 with one of the UEs 104 connected to one of the base stations 102. Link 192 may be used to indirectly obtain wireless connectivity or for D2D communications between UEs 104 and 164 without use of the base station 102. In some implementations, the link 192 is a sidelink (SL) between the UEs 104 and 164. In an example, the D2D P2P link 192 may be supported with any well-known D2D RAT, such as LTE Direct (LTE-D), WiFi Direct (WiFi-D), Bluetooth®, and so on.

The wireless communications system 100 may include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

The radar server 172 may include one or more radar servers that are to configure the wireless network to support motion detection services based on radar technologies. The radar server 172 determines which signal resources are to be used for radar, and the radar server 172 indicates to the base station 102 (and the UEs via the base station) the signal resources to be used. As used herein, a signal resource may be any suitable frequency portion or time domain portion of the signal. The signals for radar may include any suitable reference signal (RS) or data signal. In some implementations, the radar server 172 determines one or more radar RS resources to include one or more of: a DL channel state information RS (DL-CSI-RS); a DL positioning reference signal (DL-PRS, which may be indicated by a location server coupled to the core network 170); a synchronization signal block (SSB, wherein each SSB is associated with a specific transmit beam of a base station transmitting the radar RS); a SL-SSB between UEs (wherein each SL-SSB is associated with a specific transmit beam of the UE transmitting the radar RS); a SL-CSI-RS; or a SL-PRS. The radar server 172 also determines and manages motion state information for one or more UEs 104 in the wireless network 100. For example, motion state metrics for a UE 104 are reported by the base station 102 to the radar server 172 via the core network 170. The radar server 172 may determine or store a motion state for the UE 104 from the obtained motion state metrics. A motion state may be any suitable indication of the UE's motion. As noted above, the motion state may include an indication of a speed, a velocity, an acceleration, or another suitable motion. The motion state may include a range of motion or a value to indicate a specific amount of motion. The motion state may be used for configuring cell selection, handover, beamforming, locationing, or other aspects of the wireless network 100. The radar server 172 also indicates what motion state metrics are to be reported to the radar server 172. As noted above, while operations herein are described as being performed by a radar server 172 for clarity, one or more operations may be performed by another suitable network entity (such as a base station, a location server, or another suitable network entity). As such, a radar server as used herein may refer to any suitable network entity to perform the described operations.

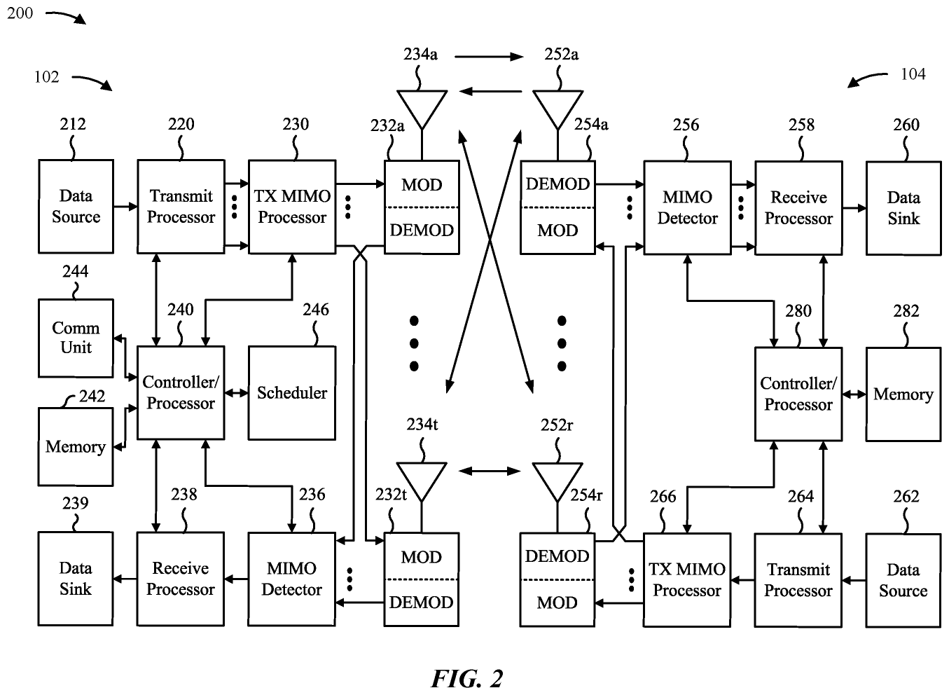

FIG. 2 shows a block diagram of a design 200 of a base station 102 and a UE 104, which may be one of the base stations and one of the UEs in FIG. 1. While design 200 depicts communications between a base station 102 and a UE 104 for the depicted examples below in describing aspects of the present disclosure, communications may be between two UEs 104 over a SL (such as a UE communicating with a relay UE), two base stations 102, or other devices of the wireless network 100. Referring to the design 200, base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 104, antennas 252a through 252r may receive the downlink signals from base station 102 and/or other base stations and may provide received signals to demodulators (DEMODs) 254a through 254r, respectively. Each demodulator 254 may condition (e.g., filter, amplify, down convert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 104 may be included in a housing.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r, and transmitted to base station 102. At base station 102, the uplink signals from UE 104 and other UEs may be received by antennas 234, processed by demodulators 232, detected by a MIMO detector 236 if applicable, and further processed by a receive processor 238 to obtain decoded data and control information sent by UE 104. Receive processor 238 may provide the decoded data to a data sink 239 and the decoded control information to controller/processor 240. Base station 102 may include communication unit 244 and communicate to another device (such as core network component) via communication unit 244.

Controller/processor 240 of base station 102, controller/processor 280 of UE 104, and/or any other component(s) of FIG. 2 may perform one or more techniques associated with performing motion detection services, as described in more detail elsewhere herein. For example, controller/processor 240 of base station 102, controller/processor 280 of UE 104, and/or any other component(s) of FIG. 2 may perform or direct operations of, for example, the described processes depicted in the figures and/or other processes as described herein. Memories 242 and 282 may store data and program codes for base station 102 and UE 104, respectively. In some aspects, memory 242 and/or memory 282 may comprise a non-transitory computer-readable medium storing one or more instructions for wireless communication. For example, the one or more instructions, when executed by one or more processors of base station 102 and/or the UE 104 may perform or direct operations of the processes as described herein. A scheduler 246 may schedule UEs for data transmission on the downlink and/or uplink. In some implementations, a scheduler may be used by a UE 104 for data transmission on a sidelink.

As indicated above, FIG. 2 is provided as an example. Other examples may differ from what is described with regard to FIG. 2 (such as communications between two UEs or other types of devices of the wireless network).

In the frequency domain for an uplink, downlink, or sidelink transmission, the available bandwidth may be divided into uniformly spaced orthogonal subcarriers (also referred to as “tones” or “bins”). For example, for a normal length cyclic prefix (CP) using, for example, 15 kHz spacing, subcarriers may be grouped into a group of 12 subcarriers. A resource of one OFDM symbol length in the time domain and one subcarrier in the frequency domain is referred to as a resource element (RE). Each grouping of the 12 subcarriers and 14 OFDM symbols is termed a resource block (RB) and, in the example above, the number of subcarriers in a resource block may be written as N_{SC}^{RB}=12. For a given channel bandwidth, the number of available resource blocks on each channel, which is also called a transmission bandwidth configuration, is indicated as N_{RB}^{DL}. For example, for a 3 MHz channel bandwidth in the above example, the number of available resource blocks on each channel is given by N_{RB}^{DL}=15. Note that the frequency component of a resource block (e.g., the 12 subcarriers) is referred to as a physical resource block (PRB).

A collection of resource elements that are used for radar based motion detection services may be referred to as a “radar resource.” If the resource elements are from one or more reference signals, the collection of resource elements may be referred to as a “radar RS resource.” The collection of resource elements can span multiple PRBs in the frequency domain and one or more symbol(s) within a slot or across slots in the time domain. A base station or UE may transmit radar resources (such as the radar RS resources) for use in motion detection services. For example, an indication of one or more radar RS resources to be used may be received at a communication unit 244 of base station 102 from a radar server 172. In some implementations, the base station 102 may configure itself to transmit the one or more radar RS resources over a downlink. In some implementations, the base station 102 may indicate the one or more radar RS resources to one or more UEs 104, and a UE 104 may transmit the one or more radar RS resources over a sidelink.

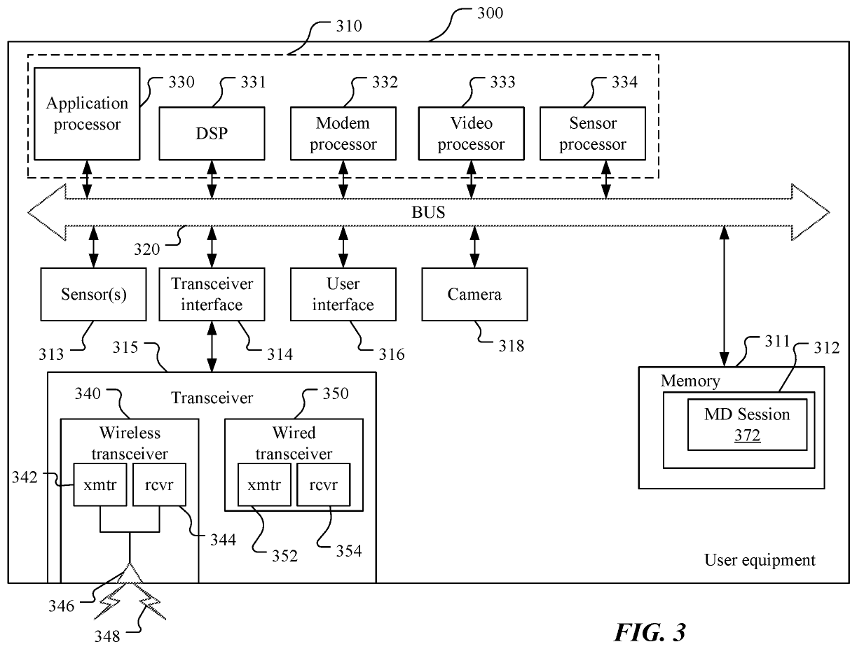

FIG. 3 illustrates a UE 300, which is an example of the UE 104, capable of supporting motion detection services in a wireless network (such as wireless network 100). For example, the UE 300 may be configured to transmit and/or receive one or more radar RS resources and/or generate one or more motion state metrics to be reported to the radar server 172. The UE 300 includes a computing platform including at least one processor 310, memory 311 including software (SW) 312, one or more sensors 313, a transceiver interface 314 for a transceiver 315, a user interface 316, and a camera 318. The processor 310, the memory 311, the sensor(s) 313, the transceiver interface 314, the user interface 316, and the camera 318 may be communicatively coupled to each other by a bus 320 (which may be configured, e.g., for optical and/or electrical communication). One or more of the shown apparatus (e.g., the camera 318 and/or one or more of the sensor(s) 313, etc.) may be omitted from the UE 300 or the UE 300 may include additional apparatus not shown (e.g., a positioning system receiver (such as a global navigation satellite system (GNSS) or a global positioning system (GPS) receiver and processing components)). The processor 310 may include one or more intelligent hardware devices, e.g., a central processing unit (CPU), a microcontroller, an application specific integrated circuit (ASIC), etc. The processor 310 may comprise multiple processors including an application processor 330, a Digital Signal Processor (DSP) 331, a modem processor 332, a video processor 333, and/or a sensor processor 334. One or more of the processors 330-334 may comprise multiple devices (e.g., multiple processors). For example, the sensor processor 334 may comprise, e.g., processors for radar, ultrasound, and/or lidar, etc. The modem processor 332 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 300 for connectivity. The memory 311 is a non-transitory storage medium that may include random access memory (RAM), flash memory, disc memory, and/or read-only memory (ROM), etc. The memory 311 stores the software 312, which may be processor-readable, processor-executable software code containing instructions that are configured to, when executed, cause the processor 310 to operate as a special purpose computer programmed to perform the various functions described herein. Alternatively, the software 312 may not be directly executable by the processor 310 but may be configured to cause the processor 310, e.g., when compiled and executed, to operate as a special purpose computer to perform the various functions described herein. The description may refer only to the processor 310 performing a function, but this includes other implementations such as where the processor 310 executes software and/or firmware. The description may refer to the processor 310 performing a function as shorthand for one or more of the processors 330-334 performing the function. The description may refer to the UE 300 performing a function as shorthand for one or more appropriate components of the UE 300 performing the function. The processor 310 may include a memory with stored instructions in addition to and/or instead of the memory 311. Functionality of the processor 310 is discussed more fully below.

The configuration of the UE 300 shown in FIG. 3 is an example and not limiting of the disclosure, including the claims, and other configurations may be used. For example, an example configuration of the UE includes one or more of the processors 330-334 of the processor 310, the memory 311, and the wireless transceiver 340. Other example configurations include one or more of the processors 330-334 of the processor 310, the memory 311, the wireless transceiver 340, and one or more of the sensor(s) 313, the user interface 316, the camera 318, and/or the wired transceiver 350.

The UE 300 may comprise the modem processor 332 that may be capable of performing baseband processing of signals received and down-converted by the transceiver 315. The modem processor 332 may perform baseband processing of signals to be upconverted for transmission by the transceiver 315. Also or alternatively, baseband processing may be performed by the processor 330 and/or the DSP 331. Other configurations, however, may be used to perform baseband processing.

The UE 300 may include the sensor(s) 313 that may include, for example, one or more of various types of sensors such as one or more inertial sensors, one or more barometric pressure sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 300 in three dimensions) and/or one or more gyroscopes capable of detecting motion including rotation of the UE 300. The sensor(s) 313 may include one or more magnetometers to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 313 may generate analog and/or digital signals indications of which may be stored in the memory 311 and processed by the DSP 331 and/or the processor 330 in support of one or more applications such as, for example, applications directed to positioning and/or navigation operations.

The sensor(s) 313 may be used in relative location measurements, relative location determination, motion determination, etc. Information detected by the sensor(s) 313 may be used for motion detection, relative displacement, dead reckoning, sensor-based location determination, and/or sensor-assisted location determination. The IMU may be configured to provide measurements about a direction of motion and/or a speed of motion of the UE 300, which may be used in relative location determination. For example, one or more accelerometers and/or one or more gyroscopes of the IMU may detect, respectively, a linear acceleration and a speed of rotation of the UE 300. The linear acceleration and speed of rotation measurements of the UE 300 may be integrated over time to determine an instantaneous direction of motion as well as a displacement of the UE 300. The instantaneous direction of motion and the displacement may be integrated to track a location of the UE 300. For example, a reference location of the UE 300 may be determined for a moment in time, and measurements from the accelerometer(s) and gyroscope(s) taken after this moment in time may be used in dead reckoning to determine present location of the UE 300 based on movement (direction and distance) of the UE 300 relative to the reference location.

The magnetometer(s) may determine magnetic field strengths in different directions which may be used to determine orientation of the UE 300. For example, the orientation may be used to provide a digital compass for the UE 300. The magnetometer may be a two-dimensional magnetometer configured to detect and provide indications of magnetic field strength in two orthogonal dimensions. Alternatively, the magnetometer may be a three-dimensional magnetometer configured to detect and provide indications of magnetic field strength in three orthogonal dimensions. The magnetometer may provide means for sensing a magnetic field and providing indications of the magnetic field, e.g., to the processor 310.

The barometric pressure sensors(s) may determine air pressure, which may be used to determine the elevation or current floor level in a building of the UE 300. For example, a differential pressure reading may be used to detect when the UE 300 has changed floor levels as well as the number of floors that have changed. The barometric pressure sensors(s) may provide means for sensing air pressure and providing indications of the air pressure, e.g., to the processor 310.

The transceiver 315 may include a wireless transceiver 340 and a wired transceiver 350 configured to communicate with other devices through wireless connections and wired connections, respectively. For example, the wireless transceiver 340 may include a transmitter 342 and receiver 344 coupled to one or more antennas 346 for transmitting (e.g., on one or more uplink channels and/or one or more sidelink channels) and/or receiving (e.g., on one or more downlink channels and/or one or more sidelink channels) wireless signals 348 and transducing signals from the wireless signals 348 to wired (e.g., electrical and/or optical) signals and from wired (e.g., electrical and/or optical) signals to the wireless signals 348. Thus, the transmitter 342 may include multiple transmitters that may be discrete components or combined/integrated components, and/or the receiver 344 may include multiple receivers that may be discrete components or combined/integrated components. The wireless transceiver 340 may be configured to communicate signals (e.g., with a base station and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 6GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 350 may include a transmitter 352 and a receiver 354 configured for wired communication. The transmitter 352 may include multiple transmitters that may be discrete components or combined/integrated components, and/or the receiver 354 may include multiple receivers that may be discrete components or combined/integrated components. The wired transceiver 350 may be configured, e.g., for optical communication and/or electrical communication. The transceiver 315 may be communicatively coupled to the transceiver interface 314, e.g., by optical and/or electrical connection. The transceiver interface 314 may be at least partially integrated with the transceiver 315. In some implementations, the transceiver 315 does not include a wired transceiver 350.

The antennas 346 may include an antenna array, which may be capable of receive beamforming or transmit beamforming, e.g., by increasing the gain setting and/or adjust the phase setting of an array of antennas in a particular direction to amplify (e.g., to increase the gain level of) the RF signals received from or transmitted towards that direction. The antennas 346 may further include a plurality of antenna panels, wherein each antenna panel is capable of beamforming. The antennas 346 are capable of adaptation, e.g., selection of one or more antennas for controlling receiving transmitted beams from or transmitting beams towards a base station or another UE. A reduced number of beams or a single beam, for example, may be selected for reception of a wide angle beam, e.g., to reduce power consumption, while an increased number of antennas in an antenna array may be selected when the transmit beam is relatively narrow. Conversely, the antennas 346 may be configured to transmit a wide angle beam or a relatively narrow beam.

The user interface 316 may comprise one or more of several devices such as, for example, a speaker, microphone, display device, vibration device, keyboard, touch screen, etc. The user interface 316 may include more than one of any of these devices. The user interface 316 may be configured to enable a user to interact with one or more applications hosted by the UE 300. For example, the user interface 316 may store indications of analog and/or digital signals in the memory 311 to be processed by DSP 331 and/or the processor 330 in response to action from a user. Similarly, applications hosted on the UE 300 may store indications of analog and/or digital signals in the memory 311 to present an output signal to a user. The user interface 316 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 316 may comprise one or more touch sensors responsive to touching and/or pressure, e.g., on a keyboard and/or touch screen of the user interface 316.

The UE 300 may include the camera 318 for capturing still or moving imagery. The camera 318 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 330 and/or the DSP 331. Also or alternatively, the video processor 333 may perform conditioning, encoding, compression, and/or manipulation of signals representing captured images. The video processor 333 may decode/decompress stored image data for presentation on a display device (not shown), e.g., of the user interface 316.

The memory 311 may store software 312 that contains executable program code or software instructions that when executed by the processor 310 may cause the processor 310 to operate as a special purpose computer programmed to perform the functions disclosed herein. As illustrated, the memory 311 may include one or more components or modules that may be implemented by the processor 310 to perform the disclosed functions. While the components or modules are illustrated as software 312 in memory 311 that is executable by the processor 310, it should be understood that the components or modules may be stored in another computer readable medium or may be dedicated hardware either in the processor 310 or off the processor. A number of software modules and data tables may reside in the memory 311 and be utilized by the processor 310 in order to manage both communications and the functionality described herein. It should be appreciated that the organization of the contents of the memory 311 as shown is merely exemplary, and as such the functionality of the modules and/or data structures may be combined, separated, and/or be structured in different ways depending upon the implementation.

The memory 311, for example, may include a motion detection (MD) module 372 that when implemented by the one or more processors 310 configures the one or more processors 310 to engage in a motion detection session for a UE in the wireless network, e.g., motion of the UE 300 or motion of a neighboring UE, as described herein. For example, the one or more processors 310 may be configured to engage in a MD session by performing one or more of transmitting one or more radar RS resources over one or more transmit beams, receiving reflections of one or more radar RS resources over one or more receive beams, measuring a motion information of a UE based on the received reflections (e.g., a motion of the UE 300 or a motion of a neighboring UE), generating a motion state report including one or more motion state metrics based on the measured motion information, or transmitting the motion state report to a base station (such as a gNB) or a relay UE (with the report ultimately being provided to a radar server coupled to the core network). While the MD session module 372 is depicted as being software included in memory 311, the MD session module 372 may be a hardware module, a software module, or a combination of hardware and software. For example, the module may include one or more application specific integrated circuits (ASICs), executable code, or a combination of both.

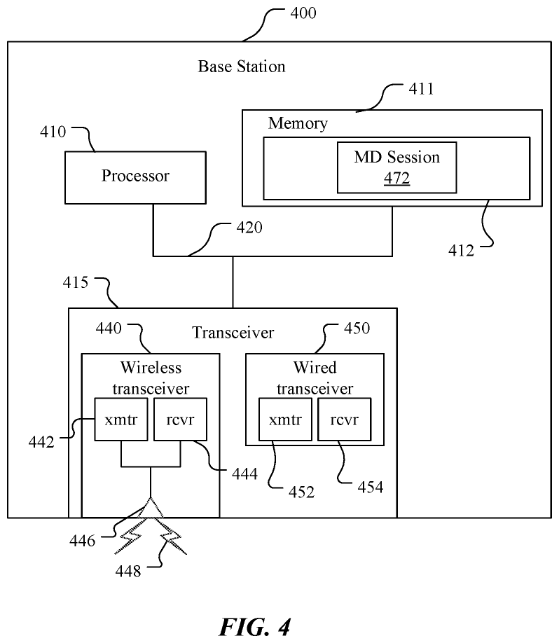

FIG. 4 illustrates a base station 400, which is an example of the base station 102, capable of supporting motion detection services in a wireless network (e.g., a cellular network). The base station 400 includes a computing platform including a at least one processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus may be omitted from the base station 400, or the base station 400 may include one or more apparatus not shown. The processor 410 may include one or more intelligent hardware devices, e.g., a central processing unit (CPU), a microcontroller, an application specific integrated circuit (ASIC), etc. The processor 410 may comprise multiple processors (e.g., including one or more of an application processor, a DSP, a modem processor, a video processor, and/or a sensor processor, similar to that shown in FIG. 3). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to operate as a special purpose computer programmed to perform the various functions described herein. Alternatively, the software 412 may not be directly executable by the processor 410 but may be configured to cause the processor 410, e.g., when compiled and executed, to operate as a special purpose computer to perform the various functions described herein. The description may refer only to the processor 410 performing a function, but this includes other implementations such as where the processor 410 executes software and/or firmware. The description may refer to the processor 410 performing a function as shorthand for one or more of the processors contained in the processor 410 performing the function. The description may refer to the base station 400 performing a function as shorthand for one or more appropriate components of the base station 400 performing the function. The processor 410 may include a memory with stored instructions in addition to and/or instead of the memory 411. Functionality of the processor 410 is discussed more fully below.

The transceiver 415 may include a wireless transceiver 440 and a wired transceiver 450 configured to communicate with other devices through wireless connections and wired connections, respectively. For example, the wireless transceiver 440 may include a transmitter 442 and receiver 444 coupled to one or more antennas 446 for transmitting and/or receiving (e.g., on one or more uplink channels and/or one or more downlink channels) wireless signals 448 and transducing signals from the wireless signals 448 to wired (e.g., electrical and/or optical) signals and from wired (e.g., electrical and/or optical) signals to the wireless signals 448. The antenna 446 is one or more antenna arrays capable of beam forming and transmitting and receiving beams, including beams used in transmitting or receiving signals (including radar RS resources) to support motion state detection of a UE in the wireless network. The transmitter 442 may include multiple transmitters that may be discrete components or combined/integrated components, and/or the receiver 444 may include multiple receivers that may be discrete components or combined/integrated components. The wireless transceiver 440 may be configured to communicate signals (e.g., with the UE 300, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 6GPP LTE-V2X (PC5), IEEE 802.11 (including IEEE 802.11p), WiFi, WiFi Direct (WiFi-D), Bluetooth®, Zigbee etc. The wired transceiver 450 may include a transmitter 452 and a receiver 454 configured for wired communication, e.g., to send communications to, and receive communications from, the radar server 172. The transmitter 452 may include multiple transmitters that may be discrete components or combined/integrated components, and/or the receiver 454 may include multiple receivers that may be discrete components or combined/integrated components. The wired transceiver 450 may be configured, e.g., for optical communication and/or electrical communication.

The configuration of the base station 400 shown in FIG. 4 is an example and not limiting of the disclosure, including the claims, and other configurations may be used. For example, the description herein discusses that the base station 400 is configured to perform or performs several functions, but one or more of these functions may be performed by the radar server 172 and/or the UE 300.

The memory 411 may store software 412 that contains executable program code or software instructions that when executed by the processor 410 may cause the processor 410 to operate as a special purpose computer programmed to perform the functions disclosed herein. As illustrated, the memory 411 may include one or more components or modules that may be implemented by the processor 410 to perform the disclosed functions. While the components or modules are illustrated as software 412 in memory 411 that is executable by the processor 410, it should be understood that the components or modules may be stored in another computer readable medium or may be dedicated hardware either in the processor 410 or off the processor. A number of software modules and data tables may reside in the memory 411 and be utilized by the processor 410 in order to manage both communications and the functionality described herein. It should be appreciated that the organization of the contents of the memory 411 as shown is merely exemplary, and as such the functionality of the modules and/or data structures may be combined, separated, and/or be structured in different ways depending upon the implementation.

The memory 411, for example, may include motion detection (MD) session module 472 that when implemented by the processor 410 configures the processor 410 to engage in a motion detection session for a UE as described herein. For example, the one or more processors 410 may configure the base station 400 to indicate the one or more radar RS resources to be used for motion state detection to one or more UEs 104 to transmit the resources, to transmit the one or more radar RS resources, to receive reflections of the one or more radar RS resources, to determine one or more motion measurements of a UE based on the reflections, to generate a motion state report including one or more motion state metrics based on the one or more motion measurements, to provide the report to the radar server 172 (such as via one or more core network components), to obtain a report from a UE 104, to relay obtained reports to the radar server 172, or generate an aggregated report from multiple reports or motion state metrics that is provided to the radar server 172. While the MD session module 472 is depicted as being software included in memory 411, the MD session module 472 may be a hardware module, a software module, or a combination of hardware and software. For example, the module may include one or more application specific integrated circuits (ASICs), executable code, or a combination of both.

Regarding motion state metrics and motion state identification based on radar, standalone radar systems determine a phase offset between the transmitted radar signal and the received reflection of the radar signal. The phase offset (also referred to as a phase difference) is associated with a round trip time (RTT) of the radar signal and indicates a depth of an object from the transmitter and receiver. Multiple depths over time indicates a motion state of the object (such as a speed, velocity, or other suitable motion degree). Determining a phase offset using single chain devices in a wireless network 100 (such as one chain of a base station 104 or a UE 102 in isolation) may be difficult because of corruption of the phase from a sampling frequency offset (SFO), carrier frequency offset (CFO), or random timing synchronization errors from the devices in the wireless network 100. To compensate for the corruptions in determining a phase offset based on a single-chain, other chains of multiple chain devices may be used to determine a phase offset between chains. Since the above corruptions of the phase are common across all chains, the phase offset between chains may be used to remove any corruptions to the phase of the single chain.

To remove corruptions to the phase in exclusively single chain devices (or without use of other chains in multiple chain devices), a phase offset may be determined between adjacent tones. For example, one or more radar RS resources are associated with defined tones of the RS, and a phase offset between the defined tones in the RS (or other adjacent tones) may be determined. Since the above corruptions of the phase impact the tones similarly, the phase offset between tones may be used to remove any corruptions to the phase of the single chain for the radar RS resources. A motion state based on measurements between tones may be based on comparing a baseline (BL) measurement of the tones to a motion detection (MD) measurement of the tones. A BL measurement refers to measuring the phases of the tones when the environment of the device performing the measurement is static (there is no movement around the device). A MD measurement refers to measuring the phases of the tones during when a motion state is to be identified. To note, the phase may refer to a phase of a channel frequency response (CFR). The motion state may be for the device itself or may be for a UE in the device's environment.

In an example of calculating a BL measurement for an example array of tones [t1,tN], a phase array for a plurality of packets of the signal including tones [tone(1),tone(N)] is determined for a plurality of sensing packets. The phase array for the ith sensing packet in a moving window across the sensing packets is depicted in equation (1) below:

PA(i)=[Δi1,Δi2, . . . ,Δi(N−1)] (1)

for Δij=|phase(tone(j))−phase(tone(j+1))|and integer j∈[1,N−1]

A BL metric g may be the average of the phase arrays across the sensing packets, as depicted in equation (2) below:

$$g = \frac{1}{{M}_{B L}} {Σ}_{i = 1}^{{M}_{B L}} PA ( i ) \qquad ( i )$$

where M_{BL} is the number of sensing packets used for the BL measurement.

A number of sensing packets M_{MD} are used for a MD measurement of an object based on the BL metric g. In an example of calculating a MD measurement, a MD metric f(t) is an average of the phase arrays across sensing packets for the MD measurement, as depicted in equation (3) below:

$$f ( t ) = \frac{1}{{M}_{MD}} {\sum }_{i = 1}^{{M}_{MD}} PA ( t - i ) \qquad ( 3 )$$

A motion state (which may also be referred to as a motion degree) may be a distance between the BL metric g and the MD metric f(t). For example, a mean square error (MSE) may be determined between the metrics, as depicted in equation (4) below:

$$Motion Degree = \frac{1}{N - 1} {( f ( t ) - g )}^{2} \qquad ( 4 )$$

The motion degree is an indication of the motion of a UE (such as a speed of the UE), and a larger number indicates a higher speed of the UE. In this manner, a device obtains reflections of the radar RS resources, determines the motion degree based on the reflections, and determines a motion state metric based on the motion degree (with the motion state metric included in a report to the radar server 172). In some implementations, the motion degree is a motion state metric reported to the radar server 172. In this manner, the report includes the determined motion degree. In some implementations, the motion state metric is an indication of the motion degree being within a range of motion degrees. For example, a “no motion” range may be associated with motion degrees from 0 to a first threshold, a “slow motion” range may be associated with motion degrees from the first threshold to a second threshold, and a “fast motion” range may be associated with motion degrees from the second threshold and above. In this manner, the device compares the motion degree to the thresholds associated with the ranges to identify the range, and the motion state metric is an indication of the identified range. While a phase difference is depicted as an example motion measurement, a device may determine other suitable motion measurements (such as a timing difference or a frequency offset), and one or more motion state metrics of a report may be based on one or more motion measurements. Example motion state metrics may include or indicate one or more of a doppler shift measurement of a device; a doppler spread measurement of the device; a speed measurement of the device; or a velocity measurement of the device.

Types of radar systems include a monostatic radar system and a multistatic radar system. A monostatic radar system includes one device both transmitting the radar signals and receiving the reflections of the radar signals. A monostatic radar system may be for identifying a motion state of the transmitting/receiving device or for identifying an object in the transmitting/receiving device's environment. A multistatic radar system includes systems with a receiving device different than a transmitting device. For example, one or more transmitting devices transmit the radar signals, and one or more separate receiving devices receive reflections of the radar signals from an object. An example multistatic radar system is a bistatic radar system in which one transmitting device transmits and one receiving device receives, but any number of transmitting devices or receiving devices may exist. A multistatic radar system may be for identifying a motion state of the object reflecting the radar signals.

A wireless network 100 may be configured for monostatic radar and/or multistatic radar (such as bistatic radar). For a monostatic radar example, a base station 102 (such as a gNB) may be configured to transmit one or more radar RS resources indicated by the radar server 172 and receive reflections of the one or more radar RS resources. In another example, a UE 104 may be configured to transmit one or more radar RS resources indicated by the radar server 172 (which may be indicated to the UE 104 by a serving base station 102 to the UE 104) and receive reflections of the one or more radar RS resources. For a multistatic radar example, a base station 102 may transmit one or more radar RS resources, and one or more UEs 104 or different base stations 102 may receive reflections of the one or more radar RS resources. For the depicted examples, the radar RS resources may be transmitted or received over a downlink, an uplink, or a sidelink for a device.

Since the radar RS resources are indicated by the radar server 172, the radar RS resources are known across the transmitting and receiving devices used for motion detection services. With the radar RS resources to be used being defined across the devices, the receiving device of the reflections can determine the motion measurements and the motion state metrics of a motion state report to be provided to the radar server 172. The receiving device generates a motion state report and provides the report to a network entity (which may be the radar server 172 or a component communicably coupled to the radar server 172, such as a base station, relay UE, or core network component). For example, if the receiving device is a UE 104, the report is provided by the UE 104 to a base station 102 (such as a gNB) during an UL transmission or a relay UE 104 during a SL transmission (with the relay UE 104 to provide the report to base station 102. If the receiving device is a base station 102 (such as a gNB), the report is provided by the base station 102 to the radar server 172 or a core network component communicably coupled to the radar server 172.

The transmitting device or the receiving device for motion detection services in the wireless network may be configured for beamforming. For example, the antenna array 234a-234t may be configured for beamforming at the base station 102 and/or the antenna array 252a-252r may be configured for beamforming at the UE 104. In this manner, one or more of the signals for motion detection services (such as one or more radar RS resources) are transmitted over one or more transmit beams and/or received over one or more receive beams. With the transmitted signals or received reflections associated with one or more transmit or receive beams, the motion state metrics determined by the receiving device are associated with the one or more beams. For example, a set of radar RS resources may be transmitted over two different transmit beams. If the set of radar RS resources over the two different transmit beams are reflected by an object and received by a receiving device, the reflections associated with the different transmit beams may differ from each other based on being transmitted over different transmit beams. Similarly, if reflections are received over two different receive beams of the receiving device, the reflections associated with the different receive beams may differ from each other based on being received over different receive beams.

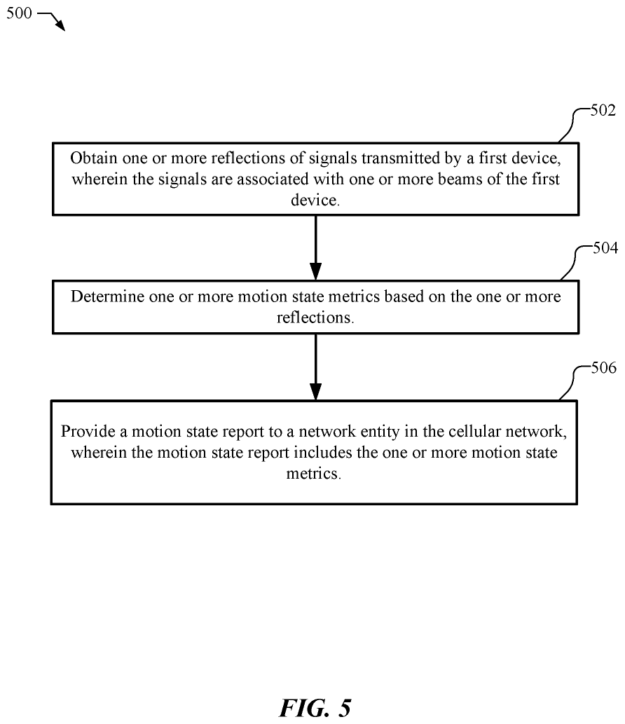

FIG. 5 shows a flowchart for an exemplary method 500 for supporting motion detection services in a wireless network. The exemplary method 500 may be performed by any suitable device of a wireless network (e.g., a cellular network), such as base station 102 or 400 shown in FIGS. 1 and 4 or a UE 104 or 300 shown in FIGS. 1 and 3, in a manner consistent with disclosed implementations. For example, a device that may perform one or more operations in method 500 may include at least one transceiver (such as one or more wireless transceivers and/or one or more wired transceivers), at least one memory, and at least one processor coupled to the at least one transceiver and the at least one memory. Referring to the UE 300 as an example device, the at least one transceiver may include the transceiver 315 or the wireless transceiver 340, the at least one memory may include the memory 311, and the at least one processor may include the processor 310 or one or more of processors 330-334. Referring to the base station 400 as an example device, the at least one transceiver may include the transceiver 415 or the wireless transceiver 440, the at least one memory may include the memory 411, and the at least one processor may include the processor 410.

At block 502, the device obtains one or more reflections of signals transmitted by a first device, wherein the signals are associated with one or more beams of the first device. Means for obtaining one or more reflections of signals transmitted by a first device may include at least one transceiver (such as a wireless transceiver) of the device. As noted above, the signals may be transmitted over one or more transmit beams of the first device. Also or alternatively, if the device performing the method 500 is the first device (such as for monostatic radar), the one or more reflections may be received over one or more receive beams. The one or more beams of the first device may include one or more transmit beams and/or one or more receive beams. A UE means for receiving the one or more reflections may include the transceiver 315 and one or more processors 310 with dedicated hardware or implementing executable code or software instructions 312 in memory 311, such as the MD session module 372 in UE 300 shown in FIG. 3. A base station means for receiving the one or more reflections may include the transceiver 415 and one or more processors 410 with dedicated hardware or implementing executable code or software instructions 412 in memory 411, such as the MD session module 472 in base station 400 shown in FIG. 4.

At block 504, the device determines one or more motion state metrics based on the one or more reflections. Means for determining one or more motion state metrics may include at least one processor of the device. With the signals associated with one or more beams of the first device, the one or more motion state metrics are associated with one or more beams of the first device. A UE means for determining one or more motion state metrics may include the one or more processors 310 with dedicated hardware or implementing executable code or software instructions 312 in memory 311, such as the MD session module 372 in UE 300 shown in FIG. 3. A base station means for determining one or more motion state metrics may include the one or more processors 410 with dedicated hardware or implementing executable code or software instructions 412 in memory 411, such as the MD session module 472 in base station 400 shown in FIG. 4.

At block 506, the device provides a motion state report to a network entity in the wireless network. Means for providing a motion state report may include at least one transceiver of the device. The motion state report includes the one or more motion state metrics. A UE means for providing the motion state report may include the transceiver 315 and one or more processors 310 with dedicated hardware or implementing executable code or software instructions 312 in memory 311, such as the MD session module 372 in UE 300 shown in FIG. 3. A base station means for providing the motion state report may include the transceiver 415 and one or more processors 410 with dedicated hardware or implementing executable code or software instructions 412 in memory 411, such as the MD session module 472 in base station 400 shown in FIG. 4. The motion state may be determined by a radar server 172 coupled to the core network 170 based on the one or more motion state metrics obtained by the radar server 172. In some implementations, a motion state of a UE is based on the one or more motion state metrics included in the motion state report

In some implementations, if the one or more beams associated with the one or more motion state metrics include one or more receive beams, the one or more motion state metrics may be associated with measurements of quasi colocation (QCL) information associated with the one or more receive beams. For example, the one or more motion state metrics may be associated with QCL-Type D information measured from the reflections. QCL information refers to the properties of a symbol or resource over one beam (which may be measured at a first set of antenna ports) that can be inferred from the symbol or resource over the other beam (which may be measured at a second set of antenna ports). QCL-Type D information refers to a spatial receive parameter, such as defined in the technical specification (TS) 38.214 of release 15 of the 3GPP set of standards. Other parameters that may be associated with the motion state metrics may be associated with other types of QCL information (e.g., QCL-Type A, B, or C information, which may include a doppler shift, doppler spread, or delay spread).

In some implementations, the propagation delay may be determined based on a known distance between the base station and the reference base station. For example, the known distance between the base station and the reference base station may be determined based on known positions of the base station and the reference base station. In another example, the base station may further perform a wireless ranging procedure with the reference base station, and wherein the known distance between the base station and the reference base station is determined based on the wireless ranging procedure.

In some implementations, the first device transmitting the signals may transmit one or more radar RS resources. If the one or more radar RS resources are transmitted over one or more transmit beams of the first device, each radar RS resource is associated with a specific transmit beam. For example, if the radar RS resources include a DL-CSI-RS, the DL-CSI-RS may be transmitted using 1, 2, 4, 8, or more orthogonal antenna ports of a base station configured for one or more transmit beams. If the radar RS resources include a DL-PRS, a location server may indicate a transmit beam of a base station to transmit the DL-PRS (wherein the base station may serve as a transmit/receive point (TRP) for locationing). If the radar RS resources include a SSB (such as a DL-SSB or a SL-SSB), each SSB is associated with a specific transmit beam. If the radar RS resources include a SL-CSI-RS or a SL-PRS, each may be associated with a transmit beam of a UE as described above with reference to a DL-CSI-RS and a DL-PRS, respectively. In this manner, the radar server 172 may indicate which radar RS resources are to be used, and the device receiving the one or more reflections of the radar RS resources may determine which transmit beam(s) are used in transmitting the radar RS resources based on the specific radar RS resources indicated. The indication from the radar server 172 may be provided to a device by any suitable device in the wireless network 100 (e.g., a base station 102 or a relay UE 104 to another UE 104, or a core network component to the base station 102). In some implementations, the indication may include instructions to associate a set of radar RS resources to a specific transmit beam (such as based on specific physical layer (PHY) channels or time windows indicated by the radar server 172 or determined by the transmitting device as described herein or explicit transmit beams indicated in the instructions). To note, the receiving device may determine the one or more receive beams based on which antenna port(s) receive the one or more reflections of the radar RS resources.

Also or alternative to a specific radar RS resource being associated with a specific transmit beam, transmissions on a specific transmit beam may be during a specific time window. For example, transmission over one or more transmit beams may be time division multiplexed (TDM). The radar server 172 may indicate a time when a radar RS resource is to be transmitted, and the time is in a time window associated with transmission over a specific transmit beams. In some implementations, the time may be in a time window associated with a receive beam of the receiving device. For time domain windows, any suitable type of signal or resource may be used for transmission, including a physical downlink shared channel (PDSCH), a physical downlink control channel (PDCCH), a physical sidelink shared channel (PSSCH), a physical sidelink control channel (PSCCH), a CSI-RS, a tracking reference signal (TRS), a synchronization signal block (SSB), a DL-PRS, a physical uplink shared channel (PUSCH), physical uplink control channel (PUCCH), or a sounding RS (SRS). In some implementations, different slots may be associated with different beams and thus different motion state metrics. For example, a first beam may be associated with a first set of one or more slots, and a second beam may be associated with a second set of one or more slots. A receiving device may determine a first motion state metric associated with the first set of one or more slots (associated with the first beam) and determine a second motion state metric associated with the second set of one or more slots (associated with the second beam). In this manner, a time window may include a plurality of consecutive symbols of a signal transmitted or received. In some implementations, a time window may include a plurality of non-consecutive symbols in a slot of the signal transmitted or received (such as a first portion and a second portion of symbols of a slot separated by one or more symbols, with the first and second portions being transmitted over a same transmit beam).

A transmit beam may be associated with one or more physical layer (PHY) channels of the transmitting device. In this manner, different transmit beams may be associated with different PHY channels. A receiving device receives the one or more reflections at one or more carrier frequencies. The one or more PHY channels of the transmitting device may be determined based on the one or more carrier frequencies, and the transmit beam(s) may be determined based on the one or more PHY channels.

A motion state report may include one or more motion state metrics and an association of the motion state metrics to one or more beams. The association may include an indication of one or more receive beams (such as QCL-Type D information), an indication of one or more transmit beams determined, an indication of the one or more radar RS resources measured in the reflections (which may indicate the transmit beam(s) used), an indication of one or more time windows associated with the reflections (which may indicate the transmit beam(s) used), an indication of one or more PHY channels (such as one or more carrier frequencies identifying channels associated with the transmit beam(s) used), or a combination of any of the above indications. An association to one or more beams may include indicating a beam index of each associated beam.

As noted above regarding phase offsets for motion measurement, determining a motion measurement of a UE may be based on a BL measurement of radar RS resources during a time when the transmitting device's and receiving device's environment is static. For example, reflections of a set of radar RS resources transmitted along a first beam may be received at the receiving device when the environment is static (which may be in a test environment or the environment being controlled to generate a BL motion measurement), and a BL motion measurement may be determined from the received reflections (such as a BL motion metric g as described above for the specific transmit beam). The BL motion measurement is thus associated with no motion occurring in an environment of the first device. When a motion state of a UE is to be determined, another set of radar RS resources may be transmitted along the first beam at a different time, and the reflections may be received at the receiving device. The receiving device may determine a first motion measurement (such as a metric f(t) as described above for the specific transmit beam) based on the received reflections. The receiving device may then determine a difference between the BL motion measurement and the first motion measurement. A motion state metric in the report to the radar server 172 may be the difference associated with the specific transmit beam.

Regarding motion measurements with reference to time windows, a receiving device determining a motion measurement may include measuring a variation of an amplitude of the signal transmitted during a time window, measuring a variation of a received signal strength (RSS) of the signal transmitted during the time window, measuring a variation of a phase of the signal transmitted during the time window, determining a quantized channel doppler response based on the measured doppler shifts from the signal transmitted during the time window, or any combination of the above.

In determining the one or more motion state metrics, the receiving device may determine one or more motion measurements and may determine one or more motion state metrics based on the one or more motion measurements. In some implementations, a motion state metric included in the report may be a motion measurement determined by the receiving device. For example, a determined motion degree (such as depicted in equation 4 above) may be the determined motion measurement, and the motion state metric in the report may be the motion degree. In some implementations, a motion measurement may be compared to one or more threshold, and the motion state metric is an indication of the comparison results. For example, the motion degree may be compared to the thresholds associated with the ranges no motion, slow motion, and fast motion as described above. The motion state metric of the report may indicate into which range the motion degree lies based on the comparison.

As noted above, the motion state report may indicate an association of the one or more motion state metrics to one or more transmit beams, one or more receive beams, one or more radar RS resources, one or more time windows, one or more PHY channels, or any combination of the above. If the indicated association is to one or more time windows, the association may be to a start time and an end time of the time window associated with a transmit beam (or a receive beam). If the association is to one or more PHY channels, the association may be to a start and end of a frequency domain window for transmitting the radar RS resources. The association to one or more time windows may include a window identifier (ID). For example, the radar server 172 may indicate a time window using a window ID, and each of one or more time windows is associated with a different window ID. As noted above, each time window is associated a transmit beam based on a configuration of transmit resources of the transmitting device (such as specific antenna ports). The association indicated in the report may include the window ID.

A motion measurement and a motion state metric may be determined for a specific transmit beam or receive beam. In this manner, a first motion state metric may be determined for a first beam, and a first motion state report includes a first motion state metric associated with a first beam. In some implementations, a second motion state metric may be determined for a second beam. The first motion state report may be an aggregated report including the second motion state metric associated with the second beam. In some implementations of an aggregated report, a device may determine a first motion state metric and a second motion state metric included in the aggregated report. In some implementations of the aggregated report, a device may receive a motion state report from another device, and the device may include a motion state metric from the received motion state report in the aggregated report. For example, a relay UE or a base station (e.g., gNB) may receive a report from one or more other UEs and aggregate the motion state metrics from the received reports into an aggregate report (which may or may not include one or more motion state metrics determined by the device). In this manner, any number of motion state metrics from any number of devices may be included in a motion state report to the radar server 172. In some implementations of the aggregated report, a motion state metric may be a statistic associated with a motion measurement. For example, example motion state metrics may include an average of the motion measurements, a median motion measurement, or another statistic or distribution measured over multiple instances of motion measurements (such as over different time instances). In some implementations of an aggregated motion state report, the aggregated motion state report may include a plurality of other motion state reports received from other devices and/or generated by the device generating the aggregated motion state report.

Also or alternatively, a second motion state report may include the second motion state metric associated with the second beam. In this manner, different motion state reports may be used to report motion state metrics associated with different beams. In some implementations, a motion state report or a motion state metric may be used as a BL report or metric. Subsequent reports or metrics may indicate a difference from the BL. For the above example, a first motion state report includes a first motion state metric. The device generating the second motion state report may determine a difference between the first motion state metric and the second motion state metric, and the second motion state report may include the determined difference to indicate the second motion state metric. Also or alternatively, any other suitable indications of a motion state metric may be included in a motion state report.

A motion measurement may be determined for reflections associated with each of multiple transmit and/or receive beams. As a result, a plurality of motion measurements are determined. The number of motion measurements increases as the number of beams increases. Each beam is oriented in a unique manner with reference to the device. For example, a specific transmit beam may be associated with a specific direction of travel of the transmissions over the transmit beam, and a specific receive beam may be associated with a specific direction of travel of the signals received over the receive beam. Motion measurements associated with a specific beam are associated with a motion of an object along the direction associated with the beam. For example, a device may receive a first set of reflections of radar RS resources transmitted over a first transmit beam for a UE travelling along a direction coinciding with an orientation of the first transmit beam, and the device may receive a second set of reflections of radar RS resources transmitted over a second transmit beam for the UE (with the orientation of the second transmit beam more orthogonal to the direction of travel of the UE than the orientation of the first transmit beam). The device may determine a first motion measurement for the UE associated with the first transmit beam, and the device may determine a second motion measurement for the UE associated with the second transmit beam. The first motion measurement is greater than the second motion measurement (such as a greater phase offset, a greater doppler shift, or a greater doppler spread) since the UE's motion coincides more with the orientation of the first transmit beam than the orientation of the second transmit beam. In this manner, the device may determine a plurality of motion measurements that vary based on the orientations of the beams associated with the motion measurements and the motion of the UE being measured.

In some implementations, the device may filter one or more motion measurements from being used to generate a motion state metric, or the device may filter one or more motion state metrics from being included in the motion state report. For example, the motion state report may be specified to include a number of motion state metrics (such as 1, 2, 4, or any other suitable number). The number of motion state metrics to be included may be indicated by the radar server 172. The device may include the motion state metrics associated with the largest motion measurements (indicating the largest motions of the UE in an associated direction) up to the number of motion state metrics in the report along with one or more associations (such as the beam index associated with each motion state metric). For example, if the motion state report is to include one motion state metric, the device may determine the motion state metric based on the largest motion measurement. In this manner, the motion state report includes the determine motion state metric for the largest motion measurement and an association to one or more parameters (e.g., a beam index for a transmit beam or a receive beam).

As noted above, the device performing method 500, including receiving the reflections, may be the same device that transmits (for a monostatic radar system) or a different device than the device that transmits (for a multistatic radar system). The receiving device may be a base station (e.g., a gNB) (which may be the same device that transmits). Also or alternatively, the receiving device may be a UE (which may be the same device or a different device than the transmitting device). If the receiving device is a UE, the UE may be measuring a motion of itself or may be measuring a motion of a neighboring UE. If the receiving device is a base station (e.g., gNB), the base station (e.g., gNB) may be measuring a motion of a UE.

One or more configurations for motion detection services, such as the configuration of beam indices, radar RS resources to measure, time-domain windows to measure, or frequency bands to measure may be indicated by the radar server 172 to a base station 102. The base station 102 may indicate the one or more configurations to one or more UEs 104 to perform operations for motion detection (such as transmitting or receiving the radar RS resources). The transmission from the base station 102 to a UE 104 may be via a broadcast or groupcast message (e.g., including a radar-specific system information block (SIB) or a positioning SIB that contains radar specific information) or any suitable unicast message.

The motion state metrics in one or more motion state reports may be used in any suitable manner by the radar server 172. In some implementations, the motion state metrics may be used by the radar server 172 to determine a location or trajectory of a UE based on the beams associated with the motion state metrics. In some implementations, the motion state metrics may be used to determine candidate base stations 102 for handover or handover criteria or to determine criteria for cell selection. UE specific information determined by the radar server 172 may also be persisted at the radar server 172 for later use in one or more wireless network operations.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Implementation examples are described in the following numbered clauses:
1. A method for supporting motion detection services in a wireless network including:
obtaining one or more reflections of signals transmitted by a first device, where the signals are associated with one or more beams of the first device;
determining one or more motion state metrics based on the one or more reflections; and
providing a motion state report to a network entity in the wireless network, where:
the motion state report includes the one or more motion state metrics; and
a motion state of a user equipment (UE) is based on the one or more motion state metrics included in the motion state report.
2. The method of clause 1, where the one or more beams include one or more of:
one or more transmit beams of the first device; or
one or more receive beams of the first device, where the one or more motion state metrics are associated with measurements of quasi colocation (QCL)-Type D information associated with the one or more receive beams.
3. The method of one or more of clauses 1-2, where the one or more motion state metrics being associated with the one or more beams is based on the one or more motion state metrics being associated with one or more of:
one or more radio detection and ranging (radar) reference signal (RS) resources transmitted by the first device along the one or more transmit beams, where each radar RS resource is associated with a specific transmit beam;
one or more time windows associated with the one or more transmit beams and/or the one or more receive beams, where each time window is associated with a specific transmit beam or a specific receive beam; or
one or more physical layer (PHY) channels of the first device, where the one or more PHY channels are associated with a transmit beam of the one or more transmit beams.
4. The method of one or more of clauses 1-3, where the one or more radar RS resources include one or more of:
a downlink (DL) channel state information RS (DL-CSI-RS);
a DL positioning reference signal (DL-PRS);
a synchronization signal block (SSB), where each SSB is associated with a specific transmit beam of the first device;
a sidelink (SL)-SSB, where each SL-SSB is associated with a specific transmit beam of the first device;
a SL-CSI-RS; or
a SL-PRS.
5. The method of one or more of clauses 1-3, where obtaining the one or more reflections of signals includes obtaining reflections of the one or more radar RS resources transmitted by the first device.
6. The method of clause 1, where determining the one or more motion state metrics includes:
determining a first motion measurement based on the one or more reflections; and
determining a first motion state metric of the one or more motion state metrics based on the first motion measurement.
7. The method of one or more of clauses 1-6, where the first motion state metric is the first motion measurement.
8. The method of one or more of clauses 1-6, where determining the first motion state metric includes comparing the first motion measurement to one or more thresholds indicated by another network entity of the wireless network, where the first motion state metric is an indication of the comparison results.
9. The method of one or more of clauses 1-8, where the first motion state metric includes an indication of:
no motion of the UE based on the first motion measurement being less than a first threshold;
slow motion of the UE based on the first motion measurement being greater than the first threshold and less than a second threshold; or
fast motion of the UE based on the first motion measurement being greater than the second threshold.
10. The method of clause 1, where:
obtaining the one or more reflections includes obtaining reflections of a first set of signals transmitted along a first beam; and
determining one or more motion state metrics includes:
determining a first motion measurement based on the reflections of the first set of signals; and
determining a first motion state metric of the one or more motion state metrics based on the first motion measurement.
11. The method of one or more of clauses 1-10, where:
obtaining the one or more reflections further includes obtaining reflections of a second set of signals transmitted along the first beam; and determining one or more motion state metrics further includes:
determining a baseline motion measurement based on the reflections of the second set of signals, where the baseline motion measurement is associated with no motion occurring in an environment of the first device; and
determining a difference between the baseline motion measurement and the first motion measurement, where the first motion state metric corresponds to the difference.
12. The method of one or more of clauses 1-10, further including obtaining, from another device in the wireless network, a request to use a second beam to determine one or more motion measurements while the first device sweeps through transmitting along a plurality of transmit beams including the first beam, where the second beam is a receive beam of the first device.
13. The method of clause 1, where:
obtaining one or more reflections of the signals includes obtaining a reflection of a signal transmitted on a transmit beam of the first device during a first time window; and
   determining the one or more motion state metrics includes:
determining a first motion measurement for the first time window based on the reflection of the signal transmitted during the first time window; and
determining a first motion state metric of the one or more motion state metrics based on the first motion measurement.
14. The method of one or more of clauses 1-13, where each time window includes a plurality of one of:
consecutive symbols of a signal; or
non-consecutive symbols in a slot of the signal.
15. The method of one or more of clauses 1-13, where the first motion measurement includes one or more of:
a measured variation of an amplitude of the signal during the first time window;
a measured variation of a received signal strength (RSS) of the signal during the first time window;
a measured variation of a phase of the signal during the first time window; or
a quantized channel doppler response based on measured doppler shifts from the signal.
16. The method of one or more of clauses 1-13, where the first motion state metric is the first motion measurement.
17. The method of one or more of clauses 1-13, where determining the first motion state metric includes comparing the first motion measurement to one or more thresholds, where the first motion state metric is an indication of the comparison results.
18. The method of one or more of clauses 1-17, where the first motion state metric includes an indication of:
no motion of the UE based on the first motion measurement being less than a first threshold;
slow motion of the UE based on the first motion measurement being greater than the first threshold and less than a second threshold; or
fast motion of the UE based on the first motion measurement being greater than the second threshold.
19. The method of one or more of clauses 1-13, where determining the first motion state metric includes determining a difference between the first motion measurement and a baseline motion measurement associated with no motion in the environment of the first device, where the first motion state metric is the difference.
20. The method of clause 1, where the motion state report indicates an association of the one or more motion state metrics to one or more of:
one or more transmit beams of the one or more beams;
one or more receive beams of the one or more beams;
one or more radio detection and ranging (radar) reference signal (RS) resources transmitted by the first device;
one or more time windows; or
one or more physical layer (PHY) channels of the first device.
21. The method of one or more of clauses 1-20, where the indicated association to the one or more time windows includes an association to:
a start time and an end time of a time window associated with a transmit beam or a receive beam of the first device.
22. The method of one or more of clauses 1-20, where the one or more motion state metrics includes a motion state metric associated with a first beam of the first device.
23. The method of one or more of clauses 1-22, further including:
determining a second motion state metric associated with a second beam of the first device; and
providing a second motion state report to the network entity, where the second motion state report includes an indication of the second motion state metric.
24. The method of one or more of clauses 1-23, where the indication of the second motion state metric includes the second motion state metric.
25. The method of one or more of clauses 1-23, where the indication of the second motion state metric includes a difference between the first motion state metric and the second motion state metric.
26. The method of one or more of clauses 1-20, further including determining a plurality of motion measurements, where:
each of the plurality of motion measurements is associated with motion of the UE along a direction of a single beam of the first device; and
the one or more motion state metrics are determined based on a subset of the plurality of motion measurements corresponding to the largest motions of the UE.
27. The method of one or more of clauses 1-26, where the one or more motion state metrics consist of a first motion state metric corresponding to a largest motion measurement and associated with a first beam of the first device.
28. The method of one or more of clauses 1-20, where the one or more motion state metrics in the motion state report include:
a first motion state metric associated with a first beam of the one or more beams; and
a second motion state metric associated with a second beam of the one or more beams.
29. The method of one or more of clauses 1-28, further including obtaining, from a user equipment (UE), a second motion state report, where:
the second motion state report includes the second motion state metric determined by the UE; and
the motion state report provided to the network entity includes a plurality of motion state reports including the second motion state report.
30. The method of one or more of clauses 1-20, where:
each of the one or more time windows is associated with a different window identifier (ID);
each of the one or more time windows is associated with a same transmit beam based on a configuration of transmit resources of the first device; and
the indication of the association to a time window of the one or more time windows in the motion state report includes the window ID of the time window.
31. The method of one or more of clauses 1-20, where:
the one or more motion state metrics are determined by the first device;
the motion state report is provided by the first device to the network entity;
before determining the one or more motion state metrics, an indication is obtained by the first device, where the indication is of the configuration of one or more of:
the one or more beams to be used for determining the one or more motion state metrics;
the one or more radar RS resources to be used for determining the one or more motion state metrics;
the one or more time windows to be used for determining the one or more motion state metrics; or
one or more frequency bands in a broadcast message to be used for determining the one or more motion state metrics.
32. The method of clause 1, where the one or more motion state metrics in the motion state report includes one or more of:
a doppler shift measurement of the first device;
a doppler spread measurement of the first device;
a speed measurement of the first device; or
a velocity measurement of the first device.
33. The method of one or more of clauses 1-32, where the device is the first device.
34. The method of one or more of clauses 1-33, where:
the first device is one of the UE or a neighboring UE; and
the network entity is one of a base station or a second UE configured to relay the motion state report towards the base station.
35. The method of one or more of clauses 1-33, where the first device is a base station.
36. The method of one or more of clauses 1-35, wherein a motion state of a user equipment (UE) is based on the one or more motion state metrics included in the motion state report.
37. A device configured for supporting motion detection services in a wireless network including:
at least one transceiver;
at least one memory; and
at least one processor coupled to the at least one transceiver and the at least one memory, where the at least one processor is configured to cause the device to:
obtain, via the at least one transceiver, one or more reflections of signals transmitted by a first device, where the signals are associated with one or more beams of the first device;
determine, via the at least one processor, one or more motion state metrics based on the one or more reflections; and
provide, via the at least one transceiver, a motion state report to a network entity in the wireless network, where the motion state report includes the one or more motion state metrics.
38. The device of clause 37, where the one or more beams include one or more of:
one or more transmit beams of the first device; or
one or more receive beams of the first device, where the one or more motion state metrics are associated with measurements of quasi colocation (QCL)-Type D information associated with the one or more receive beams.
39. The device of one or more of clauses 37-38, where the one or more motion state metrics being associated with the one or more beams is based on the one or more motion state metrics being associated with one or more of:
one or more radio detection and ranging (radar) reference signal (RS) resources transmitted by the first device along the one or more transmit beams, where each radar RS resource is associated with a specific transmit beam;
one or more time windows associated with the one or more transmit beams and/or the one or more receive beams, where each time window is associated with a specific transmit beam or a specific receive beam; or
one or more physical layer (PHY) channels of the first device, where the one or more PHY channels are associated with a transmit beam of the one or more transmit beams.
40. The device of one or more of clauses 37-39, where the one or more radar RS resources include one or more of:
a downlink (DL) channel state information RS (DL-CSI-RS);
a DL positioning reference signal (DL-PRS);
a synchronization signal block (SSB), where each SSB is associated with a specific transmit beam of the first device;
a sidelink(SL)- SSB, where each SL-SSB is associated with a specific transmit beam of the first device;
a SL-CSI-RS; or
a SL-PRS.
41. The device of one or more of clauses 37-39, where to obtain the one or more reflections of signals, the at least one processor is configured to cause the device to obtain, via the at least one transceiver, reflections of the one or more radar RS resources transmitted by the first device.
42. The device of clause 36, where to determine the one or more motion state metrics, the at least one processor is configured to cause the device to:
determine, via the at least one processor, a first motion measurement based on the one or more reflections; and
determine, via the at least one processor, a first motion state metric of the one or more motion state metrics based on the first motion measurement.
43. The device of one or more of clauses 37-42, where the first motion state metric is the first motion measurement.
44. The device of one or more of clauses 37-42, where to determine the first motion state metric, the at least one processor is configured to cause the device to compare, via the at least one processor, the first motion measurement to one or more thresholds determined by another network entity of the wireless network, where the first motion state metric is an indication of the comparison results.
45. The device of one or more of clauses 37-44, where the first motion state metric includes an indication of:
no motion of the UE based on the first motion measurement being less than a first threshold;
slow motion of the UE based on the first motion measurement being greater than the first threshold and less than a second threshold; and
fast motion of the UE based on the first motion measurement being greater than the second threshold.
46. The device of clause 37, where:
to obtain the one or more reflections, the at least one processor is configured to cause the device to obtain, via the at least one transceiver, reflections of a first set of signals transmitted along a first beam; and
to determine one or more motion state metrics, the at least one processor is configured to cause the device to:
determine, via the at least one processor, a first motion measurement based on the reflections of the first set of signals; and
determine, via the at least one processor, a first motion state metric of the one or more motion state metrics based on the first motion measurement.
47. The device of one or more of clauses 37-46, where:
to obtain the one or more reflections, the at least one processor is configured to cause the device to obtain, via the at least one transceiver, reflections of a second set of signals transmitted along the first beam; and
to determine one or more motion state metrics, the at least one processor is configured to cause the device to:
determine, via the at least one processor, a baseline motion measurement based on the reflections of the second set of signals, where the baseline motion measurement is associated with no motion occurring in an environment of the first device; and
determine, via the at least one processor, a difference between the baseline motion measurement and the first motion measurement, where the first motion state metric is the difference.
48. The device of one or more of clauses 37-46, where the at least one processor is configured to cause the device further to obtain, via the at least one transceiver and from another device in the wireless network, a request to use a second beam to determine one or more motion measurements while the first device sweeps through transmitting along a plurality of transmit beams including the first beam, where the second beam is a receive beam of the first device.
49. The device of clause 37, where:
to obtain one or more reflections of the signals, the at least one processor is configured to cause the device to obtain, via the at least one transceiver, a reflection of a signal transmitted on a transmit beam of the first device during a first time window; and
to determine the one or more motion state metrics, the at least one processor is configured to cause the device to:
determine, via the at least one processor, a first motion measurement for the first time window based on the reflection of the signal transmitted during the first time window; and
determine, via the at least one processor, a first motion state metric of the one or more motion state metrics based on the first motion measurement.
50. The device of one or more of clauses 37-49, where each time window includes a plurality of one of:
consecutive symbols of a signal; or
non-consecutive symbols in a slot of the signal.
51. The device of one or more of clauses 37-49, where the first motion measurement includes one or more of:
a measured variation of an amplitude of the signal during the first time window;
a measured variation of a received signal strength (RSS) of the signal during the first time window;
a measured variation of a phase of the signal during the first time window; or
a quantized channel doppler response based on measured doppler shifts from the signal.
52. The device of one or more of clauses 37-49, where the first motion state metric is the first motion measurement.
53. The device of one or more of clauses 37-49, where to determine the first motion state metric, the at least one processor is configured to cause the device to compare, via the at least one processor, the first motion measurement to one or more thresholds, where the first motion state metric is an indication of the comparison results.
54. The device of one or more of clauses 37-54, where the first motion state metric includes an indication of:
no motion of the UE based on the first motion measurement being less than a first threshold;
slow motion of the UE based on the first motion measurement being greater than the first threshold and less than a second threshold; and
fast motion of the UE based on the first motion measurement being greater than the second threshold.
55. The device of one or more of clauses 37-49, where, to determine the first motion state metric, the at least one processor is configured to cause the device to determine, via the at least one processor, a difference between the first motion measurement and a baseline motion measurement associated with no motion in the environment of the first device, where the first motion state metric is the difference.
56. The device of clause 37, where the motion state report indicates an association of the one or more motion state metrics to one or more of:
one or more transmit beams of the one or more beams;
one or more receive beams of the one or more beams;
one or more radio detection and ranging (radar) reference signal (RS) resources transmitted by the first device;
one or more time windows; or
one or more physical layer (PHY) channels of the first device.
57. The device of one or more of clauses 37-56, where the indicated association to the one or more time windows includes an association to:
a start time and an end time of a time window associated with a transmit beam or a receive beam of the first device.
58. The device of one or more of clauses 37-56, where the one or more motion state metrics includes a motion state metric associated with a first beam of the first device.
59. The device of one or more of clauses 37-58, where the at least one processor is configured to cause the device further to:
determine, via the at least one processor, a second motion state metric associated with a second beam of the first device; and
provide, via the at least one transceiver, a second motion state report to the network entity, where the second motion state report includes an indication of the second motion state metric.
60. The device of one or more of clauses 37-59, where the indication of the second motion state metric includes the second motion state metric.
61. The device of one or more of clauses 37-59, where the indication of the second motion state metric includes a difference between the first motion state metric and the second motion state metric.
62. The device of one or more of clauses 37-56, where the at least one processor is configured to cause the device further to determine, via the at least one processor, a plurality of motion measurements, where:
each of the plurality of motion measurements is associated with motion of the UE along a direction of a single beam of the first device; and
the one or more motion state metrics are determined based on a subset of the plurality of motion measurements corresponding to the largest motions of the UE.
63. The device of one or more of clauses 37-62, where the one or more motion state metrics consists of a first motion state metric corresponding to a largest motion measurement and associated with a first beam of the first device.
64. The device of clause 37, where the one or more motion state metrics in the motion state report include:
a first motion state metric associated with a first beam of the one or more beams; and
a second motion state metric associated with a second beam of the one or more beams.
65. The device of one or more of clauses 37-64, where the at least one processor is configured to cause the device further to obtain, via the at least one transceiver and from a user equipment (UE), a second motion state report, where:
the second motion state report includes the second motion state metric determined by the UE; and
the motion state report provided to the network entity includes a plurality of motion state reports including the second motion state report.
66. The device of one or more of clauses 37-65, where: each of the one or more time windows is associated with a different window identifier (ID);
each of the one or more time windows is associated with a same transmit beam based on a configuration of transmit resources of the first device; and
the indication of the association to a time window of the one or more time windows in the motion state report includes the window ID of the time window.
67. The device of one or more of clauses 37-66, where:
the one or more motion state metrics are to be determined by the first device;
the motion state report is to be provided by the first device to the network entity;
before determining the one or more motion state metrics, an indication is to be obtained by the first device, where the indication is of the configuration of one or more of:
the one or more beams to be used for determining the one or more motion state metrics;
the one or more radar RS resources to be used for determining the one or more motion state metrics;
the one or more time windows to be used for determining the one or more motion state metrics; or
one or more frequency bands in a broadcast message to be used for determining the one or more motion state metrics.
68. The device of clause 37, where the one or more motion state metrics in the motion state report includes one or more of:
a doppler shift measurement of the first device;
a doppler spread measurement of the first device;
a speed measurement of the first device; or
a velocity measurement of the first device.
69. The device of one or more of clauses 37-68, where the device is the first device.
70. The device of one or more of clauses 36-68, where:
the device is one of the UE or a neighboring UE; and
the network entity is one of a base station or a second UE configured to relay the motion state report towards the base station.
71. The device of one or more of clauses 37-69, where the device is a base station.
72. The device of one or more of clauses 37-71, where a motion state of a user equipment (UE) is based on the one or more motion state metrics included in the motion state report.
73. A non-transitory computer-readable medium including instructions that, when executed by at least one processor of a device configured for supporting motion detection services in a wireless network, causes the device to:
obtain, via at least one transceiver, one or more reflections of signals transmitted by a first device, where the signals are associated with one or more beams of the first device;
determine, via the at least one processor, one or more motion state metrics based on the one or more reflections; and
provide, via the at least one transceiver, a motion state report to a network entity in the wireless network, where the motion state report includes the one or more motion state metrics.
74. The computer-readable medium of clause 73, where the one or more beams include one or more of:
one or more transmit beams of the first device; or
one or more receive beams of the first device, where the one or more motion state metrics are associated with measurements of quasi colocation (QCL)-Type D information associated with the one or more receive beams.
75. The computer-readable medium of one or more of clauses 73-74, where the one or more motion state metrics being associated with the one or more beams is based on the one or more motion state metrics being associated with one or more of:
one or more radio detection and ranging (radar) reference signal (RS) resources transmitted by the first device along the one or more transmit beams, where each radar RS resource is associated with a specific transmit beam;
one or more time windows associated with the one or more transmit beams and/or the one or more receive beams, where each time window is associated with a specific transmit beam or a specific receive beam; or
one or more physical layer (PHY) channels of the first device, where the one or more PHY channels are associated with a transmit beam of the one or more transmit beams.
76. The computer-readable medium of one or more of clauses 73-75, where the one or more radar RS resources include one or more of:
a downlink (DL) channel state information RS (DL-CSI-RS);
a DL positioning reference signal (DL-PRS);
a synchronization signal block (SSB), where each SSB is associated with a specific transmit beam of the first device;
a sidelink (SL)-SSB, where each SL-SSB is associated with a specific transmit beam of the first device;
a SL-CSI-RS; or
a SL-PRS.
77. The computer-readable medium of one or more of clauses 73-75, where execution of the instructions causes the device to, in obtaining the one or more reflections of signals, obtain, via the at least one transceiver, reflections of the one or more radar RS resources transmitted by the first device.
78. The computer-readable medium of clause 73, where execution of the instructions causes the device to, in determining the one or more motion state metrics:
determine, via the at least one processor, a first motion measurement based on the one or more reflections; and
determine, via the at least one processor, a first motion state metric of the one or more motion state metrics based on the first motion measurement.
79. The computer-readable medium of one or more of clauses 73-78, where the first motion state metric is the first motion measurement.
80. The computer-readable medium of one or more of clauses 73-78, where execution of the instructions causes the device to, in determining the first motion state metric, compare, via the at least one processor, the first motion measurement to one or more thresholds determined by another network entity of the wireless network, where the first motion state metric is an indication of the comparison results.
81. The computer-readable medium of one or more of clauses 73-80, where the first motion state metric includes an indication of:
no motion of the UE based on the first motion measurement being less than a first threshold;
slow motion of the UE based on the first motion measurement being greater than the first threshold and less than a second threshold; and
fast motion of the UE based on the first motion measurement being greater than the second threshold.
82. The computer-readable medium of clause 73, where execution of the instructions causes the device to:
in obtaining the one or more reflections, obtain, via the at least one transceiver, reflections of a first set of signals transmitted along a first beam; and
in determining one or more motion state metrics:
determine, via the at least one processor, a first motion measurement based on the reflections of the first set of signals; and
determine, via the at least one processor, a first motion state metric of the one or more motion state metrics based on the first motion measurement.
83. The computer-readable medium of one or more of clauses 73-82, where execution of the instructions causes the device to:
in obtaining the one or more reflections, obtain, via the at least one transceiver, reflections of a second set of signals transmitted along the first beam; and
   in determining one or more motion state metrics:
determine, via the at least one processor, a baseline motion measurement based on the reflections of the second set of signals, where the baseline motion measurement is associated with no motion occurring in an environment of the first device; and
determine, via the at least one processor, a difference between the baseline motion measurement and the first motion measurement, where the first motion state metric is the difference.
84. The computer-readable medium of one or more of clauses 73-82, where execution of the instructions causes the device further to obtain, via the at least one transceiver and from another device in the wireless network, a request to use a second beam to determine one or more motion measurements while the first device sweeps through transmitting along a plurality of transmit beams including the first beam, where the second beam is a receive beam of the first device.
85. The computer-readable medium of clause 73, where execution of the instructions causes the device to:
in obtaining one or more reflections of the signals, obtain, via the at least one transceiver, a reflection of a signal transmitted on a transmit beam of the first device during a first time window; and in determining the one or more motion state metrics:
determine, via the at least one processor, a first motion measurement for the first time window based on the reflection of the signal transmitted during the first time window; and
determine, via the at least one processor, a first motion state metric of the one or more motion state metrics based on the first motion measurement.
86. The computer-readable medium of one or more of clauses 73-85, where each time window includes a plurality of one of:
consecutive symbols of a signal; or
non-consecutive symbols in a slot of the signal.
87. The computer-readable medium of one or more of clauses 73-85, where the first motion measurement includes one or more of:
a measured variation of an amplitude of the signal during the first time window;
a measured variation of a received signal strength (RSS) of the signal during the first time window;
a measured variation of a phase of the signal during the first time window; or
a quantized channel doppler response based on measured doppler shifts from the signal.
88. The computer-readable medium of one or more of clauses 73-85, where the first motion state metric is the first motion measurement.
89. The computer-readable medium of one or more of clauses 73-85, where the at least one processor is configured to cause the device to, in determining the first motion state metric, compare, via the at least one processor, the first motion measurement to one or more thresholds, where the first motion state metric is an indication of the comparison results.
90. The computer-readable medium of one or more of clauses 73-89, where the first motion state metric includes an indication of:
no motion of the UE based on the first motion measurement being less than a first threshold;
slow motion of the UE based on the first motion measurement being greater than the first threshold and less than a second threshold; and
fast motion of the UE based on the first motion measurement being greater than the second threshold.
91. The computer-readable medium of one or more of clauses 73-85, where execution of the instructions causes the device to, in determining the first motion state metric, determine, via the at least one processor, a difference between the first motion measurement and a baseline motion measurement associated with no motion in the environment of the first device, where the first motion state metric is the difference.
92. The computer-readable medium of clause 73, where the motion state report indicates an association of the one or more motion state metrics to one or more of:
one or more transmit beams of the one or more beams;
one or more receive beams of the one or more beams;
one or more radio detection and ranging (radar) reference signal (RS) resources transmitted by the first device;
one or more time windows; or
one or more physical layer (PHY) channels of the first device.
93. The computer-readable medium of one or more of clauses 73-92, where the indicated association to the one or more time windows includes an association to:
a start time and an end time of a time window associated with a transmit beam or a receive beam of the first device.
94. The computer-readable medium of one or more of clauses 73-92, where the one or more motion state metrics includes a motion state metric associated with a first beam of the first device.
95. The computer-readable medium of one or more of clauses 73-94, where execution of the instructions causes the device further to:
determine, via the at least one processor, a second motion state metric associated with a second beam of the first device; and
provide, via the at least one transceiver, a second motion state report to the network entity, where the second motion state report includes an indication of the second motion state metric.
96. The computer-readable medium of one or more of clauses 73-94, where the indication of the second motion state metric includes the second motion state metric.
97. The computer-readable medium of one or more of clauses 73-94, where the indication of the second motion state metric includes a difference between the first motion state metric and the second motion state metric.
98. The computer-readable medium of one or more of clauses 73-92, where execution of the instructions causes the device further to determine, via the at least one processor, a plurality of motion measurements, where:
each of the plurality of motion measurements is associated with motion of the UE along a direction of a single beam of the first device; and
the one or more motion state metrics are determined based on a subset of the plurality of motion measurements corresponding to the largest motions of the UE.
99. The computer-readable medium of one or more of clauses 73-98, where the one or more motion state metrics consists of a first motion state metric corresponding to a largest motion measurement and associated with a first beam of the first device.

100. The computer-readable medium of one or more of clauses 73-92, where the one or more motion state metrics in the motion state report include:
a first motion state metric associated with a first beam of the one or more beams; and
a second motion state metric associated with a second beam of the one or more beams.

101. The computer-readable medium of one or more of clauses 73-100, where execution of the instructions causes the device further to obtain, via the at least one transceiver and from a user equipment (UE), a second motion state report, where:
the second motion state report includes the second motion state metric determined by the UE; and
the motion state report provided to the network entity includes a plurality of motion state reports including the second motion state report.
102. The computer-readable medium of one or more of clauses 73-92, where:
each of the one or more time windows is associated with a different window identifier (ID);
each of the one or more time windows is associated with a same transmit beam based on a configuration of transmit resources of the first device; and
the indication of the association to a time window of the one or more time windows in the motion state report includes the window ID of the time window.
103. The computer-readable medium of one or more of clauses 73-92, where:
the one or more motion state metrics are to be determined by the first device;
the motion state report is to be provided by the first device to the network entity;
before determining the one or more motion state metrics, an indication is to be obtained by the first device, where the indication is of the configuration of one or more of:
the one or more beams to be used for determining the one or more motion state metrics;
the one or more radar RS resources to be used for determining the one or more motion state metrics;
the one or more time windows to be used for determining the one or more motion state metrics; or
one or more frequency bands in a broadcast message to be used for determining the one or more motion state metrics.
104. The computer-readable medium of clause 73, where the one or more motion state metrics in the motion state report includes one or more of:
a doppler shift measurement of the first device;
a doppler spread measurement of the first device;
a speed measurement of the first device; or
a velocity measurement of the first device.
105. The computer-readable medium of one or more of clauses 73-104, where the device is the first device.
106. The computer-readable medium of one or more of clauses 73-105, where:
the device is one of the UE or a neighboring UE; and
the network entity is one of a base station or a second UE configured to relay the motion state report towards the base station.
107. The computer-readable medium of one or more of clauses 73-105, where the device is a base station.
108. The computer-readable medium of clause 73, where a motion state of a user equipment (UE) is based on the one or more motion state metrics included in the motion state report.
109. A device for supporting motion detection services in a wireless network including:
means for obtaining one or more reflections of signals transmitted by a first device, where the signals are associated with one or more beams of the first device;
means for determining one or more motion state metrics based on the one or more reflections; and
means for providing a motion state report to a network entity in the wireless network, where the motion state report includes the one or more motion state metrics.
110. The device of clause 109, where the one or more beams include one or more of:
one or more transmit beams of the first device; or
one or more receive beams of the first device, where the one or more motion state metrics are associated with measurements of quasi colocation (QCL)-Type D information associated with the one or more receive beams.
111. The device of one or more of clauses 109-110, where the one or more motion state metrics being associated with the one or more beams is based on the one or more motion state metrics being associated with one or more of:
one or more radio detection and ranging (radar) reference signal (RS) resources transmitted by the first device along the one or more transmit beams, where each radar RS resource is associated with a specific transmit beam;
one or more time windows associated with the one or more transmit beams and/or the one or more receive beams, where each time window is associated with a specific transmit beam or a specific receive beam; or
one or more physical layer (PHY) channels of the first device, where the one or more PHY channels are associated with a transmit beam of the one or more transmit beams.
112. The device of one or more of clauses 109-111, where the one or more radar RS resources include one or more of:
a downlink (DL) channel state information RS (DL-CSI-RS);
a DL positioning reference signal (DL-PRS);
a synchronization signal block (SSB), where each SSB is associated with a specific transmit beam of the first device;
a sidelink (SL)-SSB, where each SL-SSB is associated with a specific transmit beam of the first device;
a SL-CSI-RS; or
a SL-PRS.
113. The device of one or more of clauses 109-111, where the means for obtaining the one or more reflections of signals includes means for obtaining reflections of the one or more radar RS resources transmitted by the first device.
114. The device of clause 106, where the means for determining the one or more motion state metrics includes:
means for determining a first motion measurement based on the one or more reflections; and
means for determining a first motion state metric of the one or more motion state metrics based on the first motion measurement.
115. The device of one or more of clauses 109-114, where the first motion state metric is the first motion measurement.
116. The device of one or more of clauses 109-114, where the means for determining the first motion state metric includes means for comparing the first motion measurement to one or more thresholds indicated by another network entity of the wireless network, where the first motion state metric is an indication of the comparison results.
117. The device of one or more of clauses 109-117, where the first motion state metric includes an indication of:
no motion of the UE based on the first motion measurement being less than a first threshold;
slow motion of the UE based on the first motion measurement being greater than the first threshold and less than a second threshold; or
fast motion of the UE based on the first motion measurement being greater than the second threshold.
118. The device of clause 109, where:
the means for obtaining the one or more reflections includes means for obtaining reflections of a first set of signals transmitted along a first beam; and
the means for determining one or more motion state metrics includes:
means for determining a first motion measurement based on the reflections of the first set of signals; and
means for determining a first motion state metric of the one or more motion state metrics based on the first motion measurement.
119. The device of one or more of clauses 109-118, where:
the means for obtaining the one or more reflections further includes means for obtaining reflections of a second set of signals transmitted along the first beam; and
   the means for determining one or more motion state metrics further includes:
means for determining a baseline motion measurement based on the reflections of the second set of signals, where the baseline motion measurement is associated with no motion occurring in an environment of the first device; and
means for determining a difference between the baseline motion measurement and the first motion measurement, where the first motion state metric corresponds to the difference.
120. The device of one or more of clauses 109-118, further including means for obtaining, from another device in the wireless network, a request to use a second beam to determine one or more motion measurements while the first device sweeps through transmitting along a plurality of transmit beams including the first beam, where the second beam is a receive beam of the first device.
121. The device of clause 109, where:
the means for obtaining one or more reflections of the signals includes means for obtaining a reflection of a signal transmitted on a transmit beam of the first device during a first time window; and the means for determining the one or more motion state metrics includes:
means for determining a first motion measurement for the first time window based on the reflection of the signal transmitted during the first time window; and
means for determining a first motion state metric of the one or more motion state metrics based on the first motion measurement.
122. The device of one or more of clauses 109-121, where each time window includes a plurality of one of:
consecutive symbols of a signal; or
non-consecutive symbols in a slot of the signal.
123. The device of one or more of clauses 109-121, where the first motion measurement includes one or more of:
a measured variation of an amplitude of the signal during the first time window;
a measured variation of a received signal strength (RSS) of the signal during the first time window;
a measured variation of a phase of the signal during the first time window; or
a quantized channel doppler response based on measured doppler shifts from the signal.
124. The device of one or more of clauses 109-121, where the first motion state metric is the first motion measurement.
125. The device of one or more of clauses 109-121, where the means for determining the first motion state metric includes means for comparing the first motion measurement to one or more thresholds, where the first motion state metric is an indication of the comparison results.
126. The device of one or more of clauses 109-125, where the first motion state metric includes an indication of:
no motion of the UE based on the first motion measurement being less than a first threshold;
slow motion of the UE based on the first motion measurement being greater than the first threshold and less than a second threshold; or
fast motion of the UE based on the first motion measurement being greater than the second threshold.
127. The device of one or more of clauses 109-121, where the means for determining the first motion state metric includes means for determining a difference between the first motion measurement and a baseline motion measurement associated with no motion in the environment of the first device, where the first motion state metric is the difference.
128. The device of clause 109, where the motion state report indicates an association of the one or more motion state metrics to one or more of:
one or more transmit beams of the one or more beams;
one or more receive beams of the one or more beams;
one or more radio detection and ranging (radar) reference signal (RS) resources transmitted by the first device;
one or more time windows; or
one or more physical layer (PHY) channels of the first device.
129. The device of one or more of clauses 109-128, where the indicated association to the one or more time windows includes an association to:
a start time and an end time of a time window associated with a transmit beam or a receive beam of the first device.
130. The device of one or more of clauses 109-128, where the one or more motion state metrics includes a motion state metric associated with a first beam of the first device.
131. The device of one or more of clauses 109-130, further including:
means for determining a second motion state metric associated with a second beam of the first device; and
means for providing a second motion state report to the network entity, where the second motion state report includes an indication of the second motion state metric.
132. The device of one or more of clauses 109-131, where the indication of the second motion state metric includes the second motion state metric.
133. The device of one or more of clauses 109-131, where the indication of the second motion state metric includes a difference between the first motion state metric and the second motion state metric.
134. The device of one or more of clauses 109-128, further including means for determining a plurality of motion measurements, where:
each of the plurality of motion measurements is associated with motion of the UE along a direction of a single beam of the first device; and
the one or more motion state metrics are determined based on a subset of the plurality of motion measurements corresponding to the largest motions of the UE.
135. The device of one or more of clauses 109-134, where the one or more motion state metrics consist of a first motion state metric corresponding to a largest motion measurement and associated with a first beam of the first device.
136. The device of one or more of clauses 109-128, where the one or more motion state metrics in the motion state report include:
a first motion state metric associated with a first beam of the one or more beams; and
a second motion state metric associated with a second beam of the one or more beams.
137. The device of one or more of clauses 109-136, further including means for obtaining, from a user equipment (UE), a second motion state report, where:
the second motion state report includes the second motion state metric determined by the UE; and
the motion state report provided to the network entity includes a plurality of motion state reports including the second motion state report.
138. The device of one or more of clauses 109-128, where:
each of the one or more time windows is associated with a different window identifier (ID);
each of the one or more time windows is associated with a same transmit beam based on a configuration of transmit resources of the first device; and
the indication of the association to a time window of the one or more time windows in the motion state report includes the window ID of the time window.
139. The device of one or more of clauses 109-128, where:
the one or more motion state metrics are determined by the first device;
the motion state report is provided by the first device to the network entity;
before determining the one or more motion state metrics, an indication is obtained by the first device, where the indication is of the configuration of one or more of:
the one or more beams to be used for determining the one or more motion state metrics;
the one or more radar RS resources to be used for determining the one or more motion state metrics;
the one or more time windows to be used for determining the one or more motion state metrics; or
one or more frequency bands in a broadcast message to be used for determining the one or more motion state metrics.
140. The device of clause 109, where the one or more motion state metrics in the motion state report includes one or more of:
a doppler shift measurement of the first device;
a doppler spread measurement of the first device;
a speed measurement of the first device; or
a velocity measurement of the first device.
141. The device of one or more of clauses 109-140, where the device is the first device.
142. The device of one or more of clauses 109-141, where:
the first device is one of the UE or a neighboring UE; and
the network entity is one of a base station or a second UE configured to relay the motion state report towards the base station.
143. The device of one or more of clauses 109-141, where the first device is a base station.
144. The device of one or more of clauses 109-143, where a motion state of a user equipment (UE) is based on the one or more motion state metrics included in the motion state report.

Therefore, it is intended that claimed subject matter not be limited to the particular examples disclosed, but that such claimed subject matter may also include all aspects falling within the scope of appended claims, and equivalents thereof.

1. A method for supporting motion detection services in a wireless network comprising:
obtaining one or more reflections of signals transmitted by a first device, wherein the signals are associated with one or more beams of the first device;
determining one or more motion state metrics based on the one or more reflections; and
providing a motion state report to a network entity in the wireless network, wherein the motion state report includes the one or more motion state metrics.

2. The method of claim 1, wherein the one or more beams include one or more of:
one or more transmit beams of the first device; or
one or more receive beams of the first device, wherein the one or more motion state metrics are associated with measurements of quasi colocation (QCL)-Type D information associated with the one or more receive beams.

3-36. (canceled)

37. A device configured for supporting motion detection services in a wireless network comprising:
at least one transceiver;
at least one memory; and
at least one processor coupled to the at least one transceiver and the at least one memory, wherein the at least one processor is configured to cause the device to:
obtain, via the at least one transceiver, one or more reflections of signals transmitted by a first device, wherein the signals are associated with one or more beams of the first device;
determine, via the at least one processor, one or more motion state metrics based on the one or more reflections; and
provide, via the at least one transceiver, a motion state report to a network entity in the wireless network, wherein the motion state report includes the one or more motion state metrics.

38. The device of claim 37, wherein the one or more beams include one or more of:
one or more transmit beams of the first device; or
one or more receive beams of the first device, wherein the one or more motion state metrics are associated with measurements of quasi colocation (QCL)-Type D information associated with the one or more receive beams.

39. The device of claim 38, wherein the one or more motion state metrics being associated with the one or more beams is based on the one or more motion state metrics being associated with one or more of:
one or more radio detection and ranging (radar) reference signal (RS) resources transmitted by the first device along the one or more transmit beams, wherein each radar RS resource is associated with a specific transmit beam;
one or more time windows associated with the one or more transmit beams and/or the one or more receive beams, wherein each time window is associated with the specific transmit beam or a specific receive beam; or
one or more physical layer (PHY) channels of the first device, wherein the one or more PHY channels are associated with a transmit beam of the one or more transmit beams.

40. The device of claim 39, wherein the one or more radar RS resources include one or more of:
a downlink (DL) channel state information RS (DL-CSI-RS);
a DL positioning reference signal (DL-PRS);
a synchronization signal block (SSB), wherein each SSB is associated with the specific transmit beam of the first device;
a sidelink (SL)-SSB, wherein each SL-SSB is associated with the specific transmit beam of the first device;
a SL-CSI-RS; or
a SL-PRS.

41. The device of claim 39, wherein, to obtain the one or more reflections of the signals, the at least one processor is configured to cause the device to obtain, via the at least one transceiver, reflections of the one or more radar RS resources transmitted by the first device.

42. The device of claim 37, wherein, to determine the one or more motion state metrics, the at least one processor is configured to cause the device to:
determine, via the at least one processor, a first motion measurement based on the one or more reflections; and
determine, via the at least one processor, a first motion state metric of the one or more motion state metrics based on the first motion measurement.

43. The device of claim 42, wherein the first motion state metric is the first motion measurement.

44. The device of claim 42, wherein, to determine the first motion state metric, the at least one processor is configured to cause the device to compare, via the at least one processor, the first motion measurement to one or more thresholds determined by another network entity of the wireless network, wherein the first motion state metric is an indication of comparison results.

45. The device of claim 44, wherein the first motion state metric includes a second indication of:
no motion of a user equipment (UE) based on the first motion measurement being less than a first threshold;
slow motion of the UE based on the first motion measurement being greater than the first threshold and less than a second threshold; and
fast motion of the UE based on the first motion measurement being greater than the second threshold.

46. The device of claim 37, wherein:
to obtain the one or more reflections, the at least one processor is configured to cause the device to obtain, via the at least one transceiver, reflections of a first set of signals transmitted along a first beam; and
to determine the one or more motion state metrics, the at least one processor is configured to cause the device to:
determine, via the at least one processor, a first motion measurement based on the reflections of the first set of signals; and
determine, via the at least one processor, a first motion state metric of the one or more motion state metrics based on the first motion measurement.

47. The device of claim 46, wherein:
to obtain the one or more reflections, the at least one processor is configured to cause the device to obtain, via the at least one transceiver, reflections of a second set of signals transmitted along the first beam; and
to determine the one or more motion state metrics, the at least one processor is configured to cause the device to:
determine, via the at least one processor, a baseline motion measurement based on the reflections of the second set of signals, wherein the baseline motion measurement is associated with no motion occurring in an environment of the first device; and
determine, via the at least one processor, a difference between the baseline motion measurement and the first motion measurement, wherein the first motion state metric is the difference.

48. The device of claim 46, wherein the at least one processor is configured to cause the device further to obtain, via the at least one transceiver and from another device in the wireless network, a request to use a second beam to determine one or more motion measurements while the first device sweeps through transmitting along a plurality of transmit beams including the first beam, wherein the second beam is a receive beam of the first device.

49. The device of claim 37, wherein:
to obtain the one or more reflections of the signals, the at least one processor is configured to cause the device to obtain, via the at least one transceiver, a reflection of a signal transmitted on a transmit beam of the first device during a first time window; and
to determine the one or more motion state metrics, the at least one processor is configured to cause the device to:
determine, via the at least one processor, a first motion measurement for the first time window based on the reflection of the signal transmitted during the first time window; and
determine, via the at least one processor, a first motion state metric of the one or more motion state metrics based on the first motion measurement.

50. The device of claim 49, wherein each time window includes a plurality of one of:
consecutive symbols of the signal; or
non-consecutive symbols in a slot of the signal.

51. The device of claim 49, wherein the first motion measurement includes one or more of:
a measured variation of an amplitude of the signal during the first time window;
a measured variation of a received signal strength (RSS) of the signal during the first time window;
a measured variation of a phase of the signal during the first time window; or
a quantized channel doppler response based on measured doppler shifts from the signal.

52. The device of claim 49, wherein the first motion state metric is the first motion measurement.

53. The device of claim 49, wherein to determine the first motion state metric, the at least one processor is configured to cause the device to compare, via the at least one processor, the first motion measurement to one or more thresholds, wherein the first motion state metric is an indication of comparison results.

54. The device of claim 53, wherein the first motion state metric includes a second indication of:
no motion of a user equipment (UE) based on the first motion measurement being less than a first threshold;
slow motion of the UE based on the first motion measurement being greater than the first threshold and less than a second threshold; and
fast motion of the UE based on the first motion measurement being greater than the second threshold.

55. The device of claim 49, wherein to determine the first motion state metric, the at least one processor is configured to cause the device to determine, via the at least one processor, a difference between the first motion measurement and a baseline motion measurement associated with no motion in an environment of the first device, wherein the first motion state metric is the difference.

56. The device of claim 37, wherein the motion state report indicates an association of the one or more motion state metrics to one or more of:
one or more transmit beams of the one or more beams;
one or more receive beams of the one or more beams;
one or more radio detection and ranging (radar) reference signal (RS) resources transmitted by the first device;
one or more time windows; or
one or more physical layer (PHY) channels of the first device.

57. The device of claim 56, wherein the indicated association to the one or more time windows includes an association to:
a start time and an end time of a time window associated with a transmit beam or a receive beam of the first device.

58. The device of claim 56, wherein the one or more motion state metrics comprises a motion state metric associated with a first beam of the first device.

59. The device of claim 58, wherein the at least one processor is configured to cause the device further to:
determine, via the at least one processor, a second motion state metric associated with a second beam of the first device; and
provide, via the at least one transceiver, a second motion state report to the network entity, wherein the second motion state report includes an indication of the second motion state metric.

60. The device of claim 59, wherein the indication of the second motion state metric includes the second motion state metric.

61. The device of claim 59, wherein the indication of the second motion state metric includes a difference between the first motion state metric and the second motion state metric.

62. The device of claim 56, wherein the at least one processor is configured to cause the device further to determine, via the at least one processor, a plurality of motion measurements, wherein:
each of the plurality of motion measurements is associated with motion of a user equipment (UE) along a direction of a single beam of the first device; and
the one or more motion state metrics are determined based on a subset of the plurality of motion measurements corresponding to largest motions of the UE.

63. The device of claim 62, wherein the one or more motion state metrics consists of a first motion state metric corresponding to a largest motion measurement and associated with a first beam of the first device.

64. The device of claim 37, wherein the one or more motion state metrics in the motion state report include:
a first motion state metric associated with a first beam of the one or more beams; and
a second motion state metric associated with a second beam of the one or more beams.

65. The device of claim 64, wherein the at least one processor is configured to cause the device further to obtain, via the at least one transceiver and from a user equipment (UE), a second motion state report, wherein:
the second motion state report includes the second motion state metric determined by the UE; and
the motion state report provided to the network entity includes a plurality of motion state reports including the second motion state report.

66. The device of claim 65, wherein:
each of one or more time windows is associated with a different window identifier (ID);
each of the one or more time windows is associated with a same transmit beam based on a configuration of transmit resources of the first device; and
an indication of the association to a time window of the one or more time windows in the motion state report includes the window ID of the time window.

67. The device of claim 65, wherein:
the one or more motion state metrics are to be determined by the first device;
the motion state report is to be provided by the first device to the network entity;
before determining the one or more motion state metrics, an indication is to be obtained by the first device, wherein the indication is of the configuration of one or more of:
the one or more beams to be used for determining the one or more motion state metrics;
one or more radar reference signal (RS) resources to be used for determining the one or more motion state metrics;
one or more time windows to be used for determining the one or more motion state metrics; or
one or more frequency bands in a broadcast message to be used for determining the one or more motion state metrics.

68. The device of claim 37, wherein the one or more motion state metrics in the motion state report includes one or more of:
a doppler shift measurement of the first device;
a doppler spread measurement of the first device;
a speed measurement of the first device; or
a velocity measurement of the first device.

69. The device of claim 37, wherein the device is the first device.

70. The device of claim 69, wherein:
the device is one of a user equipment (UE) or a neighboring UE; and
the network entity is one of a base station or a second UE configured to relay the motion state report towards the base station.

71. The device of claim 69, wherein the device is a base station.

72. The device of claim 37, wherein a motion state of a user equipment (UE) is based on the one or more motion state metrics included in the motion state report.

73. A non-transitory computer-readable medium including instructions that, when executed by at least one processor of a device configured for supporting motion detection services in a wireless network, causes the device to:
obtain, via at least one transceiver, one or more reflections of signals transmitted by a first device, wherein the signals are associated with one or more beams of the first device;
determine, via the at least one processor, one or more motion state metrics based on the one or more reflections; and
provide, via the at least one transceiver, a motion state report to a network entity in the wireless network, wherein the motion state report includes the one or more motion state metrics.

74-108. (canceled)

109. A device for supporting motion detection services in a wireless network comprising:
means for obtaining one or more reflections of signals transmitted by a first device, wherein the signals are associated with one or more beams of the first device;
means for determining one or more motion state metrics based on the one or more reflections; and
means for providing a motion state report to a network entity in the wireless network, wherein the motion state report includes the one or more motion state metrics.

110-144. (canceled)
